(19) United States
(12) Patent Application Publication
(10) Pub. No.: US 2004/0158486 A1
(43) Pub. Date: Aug. 12, 2004

(54) Healthcare solution system

(76) Inventors: Audrey J. Nudd, Round Rock, TX (US); Keith E. Argenbright, Fort Worth, TX (US); Ronald E. Galbraith, Nashville, TN (US); Vinod R. Marur, Berkeley Heights, NJ (US); Prithwiraj Ghosh, Karnataka (IN); Susan P. Milam, Austin, TX (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 10/479,772

(22) PCT Filed: Jun. 11, 2001
(86) PCT No.: PCT/US01/18760

(51) Int. Cl. G06F 17/60

(52) U.S. Cl. 705/8

(57) ABSTRACT

A healthcare solution system includes electronic appointment scheduling, medical inquiry session customization, patient response message customization, and broadcast messaging. The appointment scheduling allows patients to use a single front end user interface to communicate with plural medical providers who have disparate backend appointment systems, or no appointment system. The medical inquiry session customization allows medical providers to individually tailor queries and response options related to electronically solicited medical inquiries, such as an electronically requested patient history. The patient response message customization allows the provider to individually tailor responses to patient e-mail inquiries generated within the healthcare solution system. Broadcast messaging allows medical providers to target medical-related information to specific patients who may benefit from the message without compromising the confidentiality of the patients.

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

The current trend in medicine is to provide Internet-based tools to improve communication between patients and medical providers, and to enable patients to become active participants in the management of their health. However, as discussed in more detail below, there are many deficiencies in the flexibility and versatility of existing Internet-based tools.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings an embodiment that is presently preferred. It should be understood, however, that the invention is not limited to the precise arrangements and instrumentalities shown. In the drawings:

FIGS. 1A-1K show a message administration table for use in the present invention;

FIG. 2 shows a flowchart of the medical history customization process in accordance with the present invention;

FIG. 3 shows a flowchart of the medical history process in accordance with the present invention;

FIG. 4 shows the contents of a patient's medical history;

FIG. 5 shows a user interface screen which allows a patient to input a response to a preprogrammed customized query;

FIGS. 6A-6C are tables that show appointment scheduling permissions;

FIG. 7 shows appointment codes and definitions;

FIG. 8 is a table that shows appointment reasons;

FIGS. 9A-9B, taken together, is a table that shows appointment module messages;

FIG. 10 is a flowchart of the patient appointment request process in accordance with the present invention;

FIGS. 11-19 are screen shots of user interface displays experienced by patients and medical providers during the appointment scheduling process;

FIG. 20 is a table that shows history and components of stored messages;

FIG. 21 is a table that shows history of messages sent;

FIG. 22 shows a drop-down box of a user interface for selecting health criteria of a message;

FIG. 23 is a flowchart of the broadcast messaging process in accordance with the present invention;

FIGS. 24-32 are screen shots of user interface displays for implementing broadcast messaging; and

FIGS. 33A and 33B, taken together, show contents of user interface displays for allowing a medical provider to create different standardized response messages.

### BRIEF SUMMARY OF THE INVENTION

A healthcare solution system includes electronic appointment scheduling, medical inquiry session customization, patient response message customization, and broadcast messaging. The appointment scheduling allows patients to use a single front end user interface to communicate with plural medical providers who have disparate backend appointment systems, or no appointment system. The medical inquiry session customization allows medical providers to individually tailor queries and response options related to electronically solicited medical inquiries, such as an electronically requested patient history. The patient response message customization allows the provider to individually tailor responses to patient e-mail inquiries generated within the healthcare solution system. Broadcast messaging allows medical providers to target medical-related information to specific patients who may benefit from the message without compromising the confidentiality of the patients.

### DETAILED DESCRIPTION OF THE INVENTION

Certain terminology is used herein for convenience only and is not to be taken as a limitation on the present invention. In the drawings, the same reference letters are employed for designating the same elements throughout the several figures.

The present invention is described in the context of a software application called MyDoc Online, which is being commercialized by MyDoc Online, Inc., Round Rock, Tex. (www.mydoconline.com). However, the scope of the present invention is not limited to this particular implementation of the invention. The present invention is described in the context of a plurality of distributed computers, all of which are linked together by an electronic network A-G, such as the Internet. The computers may be any type of computing device that allows a user to interact with a web site via a web browser. For example, the computers may be a personal computers (PC) that run a Windows operating system. The computers may also be handheld, wireless devices. Patients, medical providers (e.g., hospital, clinical facility), and medical practitioners each communicate via a computer with a central host computer or a plurality of distributed host computers. The software application may be located at the host in a thin client or application service provider (ASP) architecture, or the software application may reside on the local user computers.

### DEFINITIONS AND ACRONYMS

The following acronyms and definitions are provided to promote understanding of the invention.

ASP—application service provider

FP—family practice

HMO—healthcare maintenance organization

MAT—Message Administration Table

MDOL—MyDoc Online

MM—medical location manager

MLU—medical location user

MO—medical organization

MOM—medical organization manager

PC—personal computer

PPMS—Physician Practice Management System

UI—user interface

medical provider—the medical provider may be a physician or doctor, dentist, healthcare maintenance organization (HMO), hospital, healthcare clinic, managed care entity, and the like. The medical provider also includes the individuals who are authorized to create and edit the medical provider's records and customized settings in MyDoc Online.

### OVERVIEW OF PRESENT INVENTION

I. Customization of patient user interface. One significant market barrier to the introduction of healthcare Internet solutions is that a company which invests the time and money to create an online application cannot readily customize the content of patient interaction screens. Medical providers are highly sensitive to the types of information that they wish to display to, and receive from, patients. Each medical provider has different needs and expectations for the contents associated with automated two-way communication with patients. Thus, while one healthcare solution provider may spend a lot of money developing a comprehensive application for one medical provider, the application will not likely be acceptable to another medical provider unless significant modifications are made. The healthcare solution provider must then expend considerable time reprogramming the application for each medical provider. Often, new code must be written to modify hard-coded portions of the application. The cost of repeating this process for each medical provider is prohibitive and is one reason why healthcare Internet solutions are not in widespread use today, even though the technology is readily available, Internet penetration in the home is very high, and patients are very interested in improving their communication avenues with their medical providers.

The present invention addresses some of these deficiencies in the healthcare Internet solutions marketplace by providing the ability to customize content of a medical inquiry session to be presented by a medical provider to a patient via a user interface. The content of the medical inquiry session typically includes a plurality of queries and associated response types. In its broadest sense, the present invention operates as follows:

1. A table is provided for storing information that defines customizable or partially customizable elements of the medical inquiry session.

2. A medical provider is presented with an input screen to select the customizable or partially customizable elements.

3. The selected customized or partially customized elements are stored in the table. Each medical provider may thus define different queries and different response types, thereby providing their respective patients with different medical inquiry sessions.

The table also includes information that defines non-customizable fixed elements of the medical inquiry session. In use, the medical provider is presented with an input screen to select or deselect the non-customizable fixed elements. The medical provider's selection/deselection choice is stored in the table. When the medical inquiry session is presented to the patient, it includes only the selected non-customizable fixed elements and the customized elements.

A partially customizable element may allow for variations in fixed text queries or the selection of a particular response type (e.g., a fixed response or a free-form text response). In contrast, a (fully) customizable element may allow for the complete addition or removal of a fixed text query of non-customizable content and the corresponding response selections.

Consider, for example, a medical inquiry session which presents a medical history. A first medical provider may wish to include a particular grouping of 16 query/response pairs out of a total grouping of 20 default query/response pairs, whereas a second medical provider may wish to include a different particular grouping of 16 query/response pairs. A third medical provider may wish to include 10 of the query/response pairs, but may wish to modify the text in some customizable queries, and may wish to request that all responses are input as free-form text to maximize the flow of information provided by the patient to the medical provider. Yet a fourth medical provider may wish to include the same 10 query/response pairs as the third medical provider, but may wish to modify the text in some customizable queries in a different manner as the third medical provider, and may wish to request that all responses are input as fixed responses to make the medical history simpler for the patient and to minimize the interpretation time spent by the medical provider in analyzing the patient responses. The present invention, by using the table, allows for all of these options to occur. The table is described in further detail below, and is referred to as a Message Administration Table (MAT).

II. Patient appointments with interfaced and non-interfaced medical providers. Another marketplace barrier to implementing healthcare Internet solutions is the tremendous amount of backend integration that is necessary to present a seamless front end appearance to the patients. Customer expectations for web-based communications are very high. As a result, medical providers are often reluctant to provide such tools to patients because the expectations for prompt and accurate responses cannot be met, given the overwhelmingly manual, paper-based ways in which most medical offices run. Furthermore, medical providers who have implemented automation tools, such as electronic scheduling (appointment) systems, must still rely upon phone interactions between patients and a skilled medical operator to book the appointments. Even when medical providers use electronic scheduling systems, the systems may not integrate well into applications that come with healthcare Internet solutions. Medical providers may also be reluctant to allow for such integration due to privacy concerns. Furthermore, a medical provider may be part of a network of plural offices and different types of practices, each having their own appointment systems, styles and needs. Appointment scheduling is an obvious, and expected, feature of a commercially successful healthcare Internet solution. The current lack of a solution to the many issues regarding appointments systems is a significant barrier to implementing such solutions.

The present invention addresses this issue by allowing patients to submit appointment requests to a single front end interface which services a plurality of medical providers, each of whom may have different appointment systems, or whom may have no automated appointment systems. The patient experiences the same front end interface regardless of the disparate backend arrangements of the medical providers. This increases the patient's acceptance of the automated experience, even though parts of the system are not fully automated.

In its broadest sense, the present invention provides a computer-implemented scheme for scheduling appointments between customers and a plurality of service providers, wherein at least some of the service providers have an electronic scheduling system. In one embodiment of the present invention described herein, the service provider is a medical provider and the customers are patients or potential patients of the medical providers. In the broadest sense, the process operates as follows:

1. An electronic interface is provided which allows for communication with a plurality of customers who access the electronic interface via a customer user interface to request appointments. The electronic interface also allows for communication with a plurality of electronic scheduling systems of at least some of the service providers. The electronic interface includes a table that indicates which service providers have an electronic scheduling system that is available for automatic scheduling of appointments, and which service providers do not have an electronic scheduling system that is available for automatic scheduling of appointments. Preferably, the user interface is a browser and the electronic interface communicates with the customer user interface via an electronic or global network.

2. Upon request by a customer via the user interface for an appointment with a specific service provider, the table is used to determine if an automatic appointment can be made.

3. The electronic interface sends the customer a first response if an automatic appointment can be made, and the electronic interface sends the customer a second response if an automatic appointment cannot be made.

If it is determined from the table that an automatic appointment can be made, the customer's appointment request is electronically forwarded from the electronic interface to the electronic scheduling system of the specified service provider. The service provider's response, which is the first response referred to above, is then received back at the electronic interface. Customized messages stored in the table are linked to specific service providers. In this manner, the first response includes any customized messages associated with the customer's requested service provider.

The table further includes one or more conditions for selected service providers which define when the electronic scheduling system of the respective service provider is available for automatic scheduling of appointments. These conditions are used to determine from the table if an automatic appointment can be made. The conditions may include type of appointment request, date of the request, and time of day of the request. For example, a first provider may wish to allow patients to automatically schedule annual gynecology appointments, but may not wish to allow patients to automatically schedule non-emergency office visits. A second provider may wish to exclude certain dates or times of day from automatic scheduling.

The conditions may also include a “resource” of the service provider. For example, a service provider such as a medical provider may have a plurality of different physicians (i.e., resources). One physician may allow for electronic scheduling, whereas another physician may not want to allow for electronic scheduling, or may not be equipped to facilitate electronic scheduling.

Preferably, the second response does not indicate whether or not the service provider has an electronic scheduling system in communication with the electronic interface. In this manner, a single customer user interface and system interface can be used with a plurality of service providers, even if some of the service providers cannot provide a 100% seamless, electronic and automated communication path with the customers.

The second response may be a request that the customer resubmits the appointment request at a subsequent point in time. Alternatively, the second response may be a request to the customer that the customer submits one or more alternative appointment requests which will be subsequently confirmed.

In one implementation of the patient appointment features, the MAT is used to create customized response messages for different medical providers.

III. Broadcast messaging. To fully leverage the advantages of a healthcare Internet solution that allows for communication between patients and medical providers, it would be desirable to provide application software that would identify patients who fit certain criteria and to e-mail selected messages to such patients. Broadcast messaging software for targeting selected e-mail addresses exist in the prior art. However, timeliness issues and privacy issues require that a different approach be taken for broadcast messaging in a healthcare Internet solution, especially when the patient is provided with a secure e-mail address that is completely separate from unsecure e-mail addresses of the patient. Consider, for example, that a patient is enrolled in a healthcare Internet solution and has a private, secure mailbox for communicating with the medical provider. The patient may check their work e-mail address and/or unsecure e-mail address (e.g., HOTMAIL, AOL, etc . . . ) on a regular basis, but will not check their private, secure mailbox on any regular basis. This may defeat the advantages of a broadcast messaging feature within the healthcare Internet solution because messages will not be delivered in a timely manner to all desired recipients. Furthermore, the messages delivered to an unsecure e-mail address may be accessible by persons other than the mailbox recipient, especially in the case of a work e-mail address or a shared home e-mail address. The present invention addresses these concerns by a novel message targeting and delivery process.

In the broadest sense, the process of delivering messages to patients of a medical provider operates as follows:

1. Each patient has an individual profile which may include demographics and health criteria (e.g., known conditions or diseases).

2. The medical provider initiates an electronic message to be broadcast to the patients. The message relates to medical information of interest to at least some of the patients. For example, a pediatrician may compose a reminder message that the final DPT vaccination is due.

3. The medical provider creates a patient profile for the electronic message defining the criteria for deciding which patients should receive the electronic message. Using the DPT example, the patient profile may target all children between the ages of 4-6, which is the recommended age for the final DPT vaccination. The patient profile may also target all children who have not already had the vaccination, assuming that there is a searchable field in the medical records for this information.

4. The patient profile of the electronic message is then compared with the individual profile of the medical provider's patients to determine a subset of patients that match the patient profile.

5. The electronic message is electronically sent to a secure electronic mailbox of the subset of patients. In the example above, the actual e-mail message is sent to the mailbox of the children's parent or guardian.

6. A pickup message is sent to an unsecure mailbox of the subset of patients informing the subset of patients that the electronic message has been sent to the patient's secure mailbox. The substantive content of the electronic message does not appear in the pickup message. In this manner, the privacy of the electronic message is preserved.

Preferably, the medical provider has a web site with a host computer, and each patient has an internal e-mail address in the medical provider's host computer that is accessible by the patients via a browser. In this configuration, the secure mailboxes are the internal e-mail addresses of the patients in the medical provider's host computer, and the unsecure mailboxes are e-mail addresses of the patients that are not associated with the medical provider's host computer (e.g., HOTMAIL, AOL, etc.).

IV. Creation of a response message to patient e-mails using a formatted template. To fully leverage the advantages of a healthcare Internet solution, e-mail communication capabilities should be provided between patients and medical providers. As discussed in section I above, one significant market barrier to the introduction of healthcare Internet solutions is that a company which invests the time and money to create an online application cannot readily customize the content of patient interaction screens. The same customization difficulties exist at the medical provider end in developing customized messages for delivery to patients. The present invention addresses this deficiency by providing the ability to customize content of response messages to patient e-mails using a formatted template.

The use of canned messages in responding to customer e-mails is well-known. Many e-mail systems include autoresponders which interpret the customer's e-mails and send back appropriate canned message responses. However, the canned message creation process provided in e-mail management systems have limited flexibility.

In its broadest sense, the present invention creates standardized responses for a plurality of different types of patient inquiries that are electronically submitted by patients to a remotely located computer management system of a medical provider, and operates as follows:

1. A message response template is electronically presented that displays a standardized inquiry response that includes a fixed text portion and one or more customizable text portions, and/or an input section for each customizable text portion.

2. A user selects the customized text for each of the customizable text portions. In this manner, a plurality of medical providers may present different standardized responses to the same patient inquiries.

The patient inquiries may be appointment requests, billing questions, prescription refill requests, lab results, or medical questions. The customizable text portion may state the time frame for a response from the medical provider, or it may state the communication method for a response from the medical provider. Other customizable features are within the scope of the present invention.

### DETAILED DESCRIPTION

I. Customization of patient user interface.

As described above, this feature of the present invention allows a medical provider to customize content of a medical inquiry session to be presented by a medical provider to a patient via a user interface. One example of this feature allows a medical provider to customize a medical history. The specifications for one such example is provided below.

A patient's medical history contains three sections, a general section, a specialty-related section, and a section customized by each medical provider (or their proxy).

General: A set of basic information about the patient's past medical experiences and events that provides personal information, lifestyle choices, past medical history, and a list of past immunizations and/or health diagnostic tests. MDOL creates the fields in this section. The general form is used by providers in family practice, and practice specialties. For pediatrics the General Form has a pediatrics addendum where a parent will be asked to complete the section if the patient is under the age of 18 years. The MO cannot customize this section.

Specialty-related: A set of basic information about the patient's past medical experiences and events that are specific and more detailed regarding a certain specialty (e.g., cardiology or allergy), except for Family Practice, General Practice, and Pediatrics. MDOL creates the fields in this section. The MO cannot customize this section.

Customized by individual medical provider: Each medical provider is allowed to ask for up to 15 additional pieces of information those were not included in the General or Specialty-related sections.

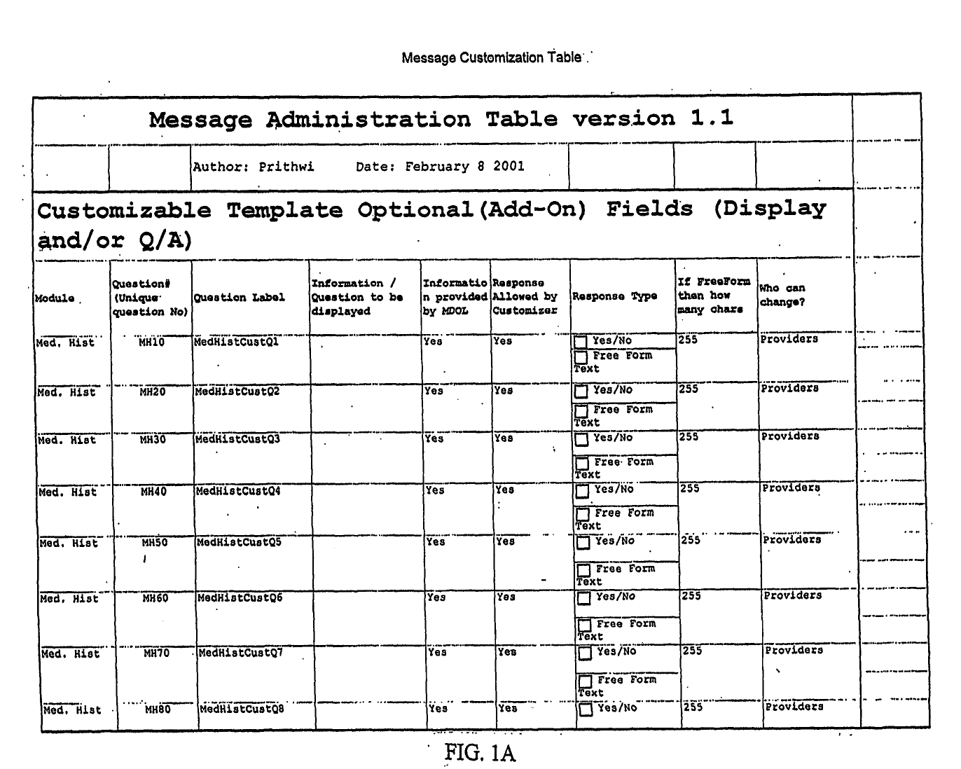

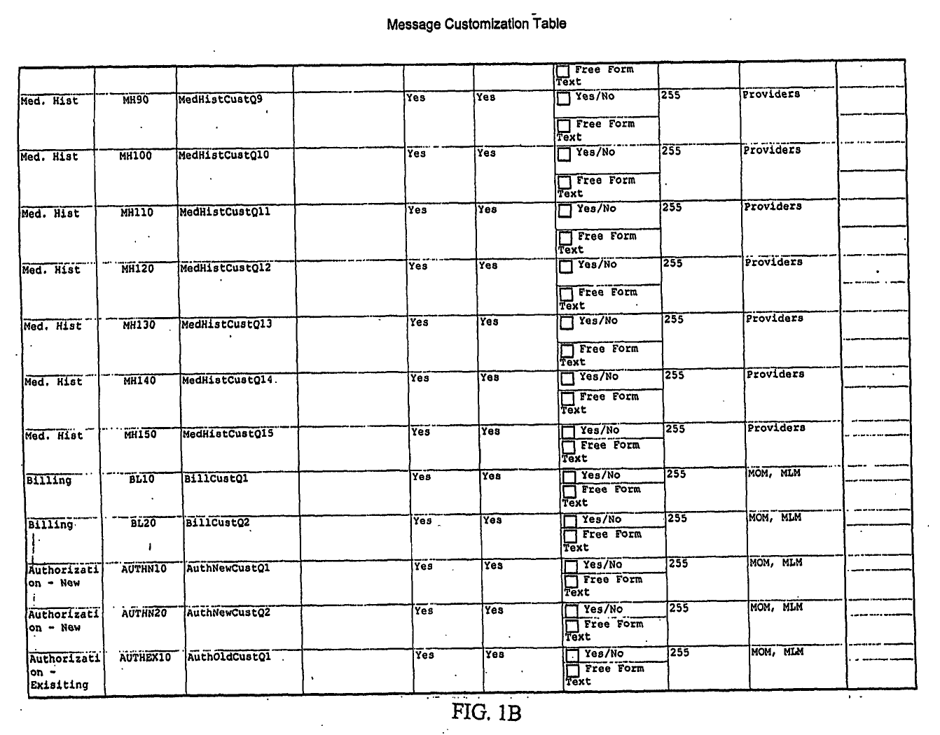

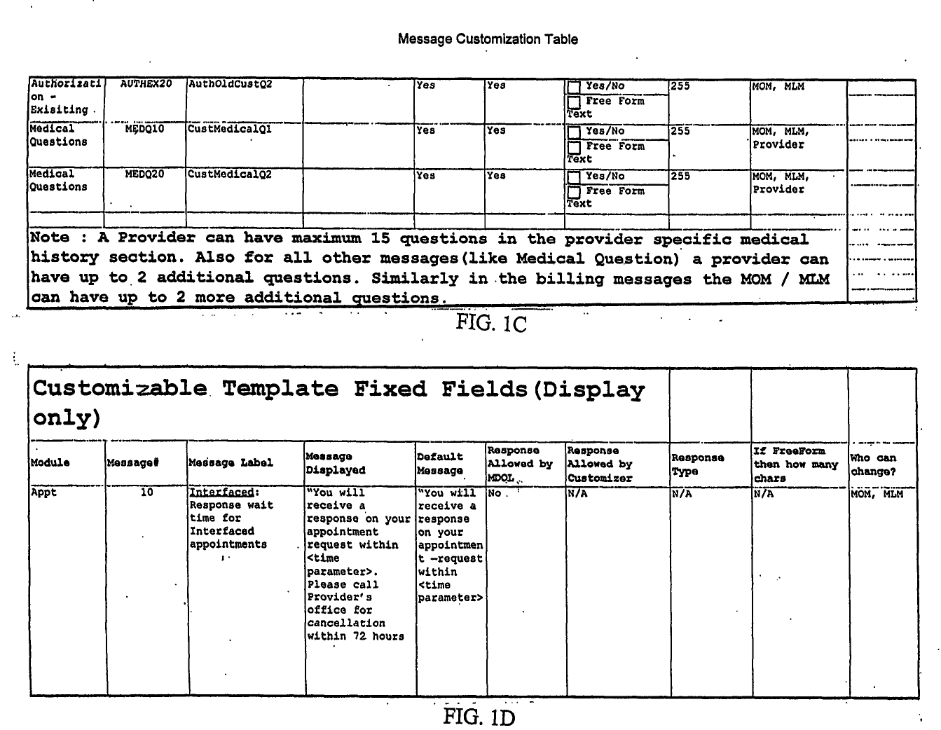

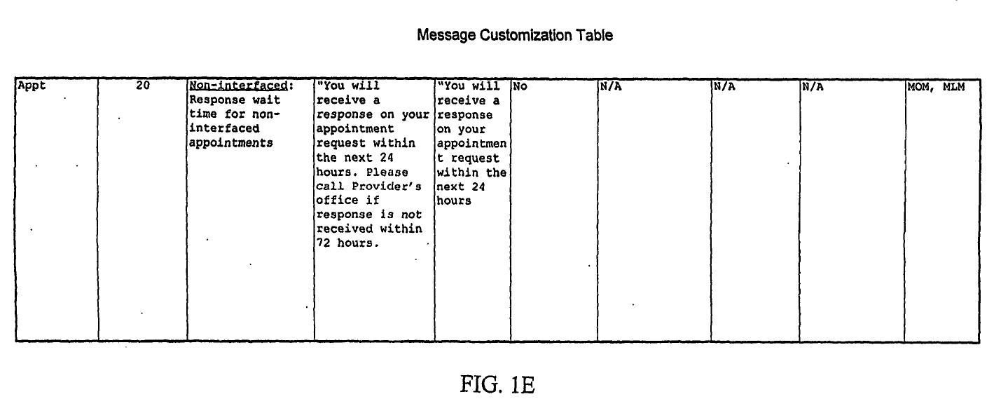

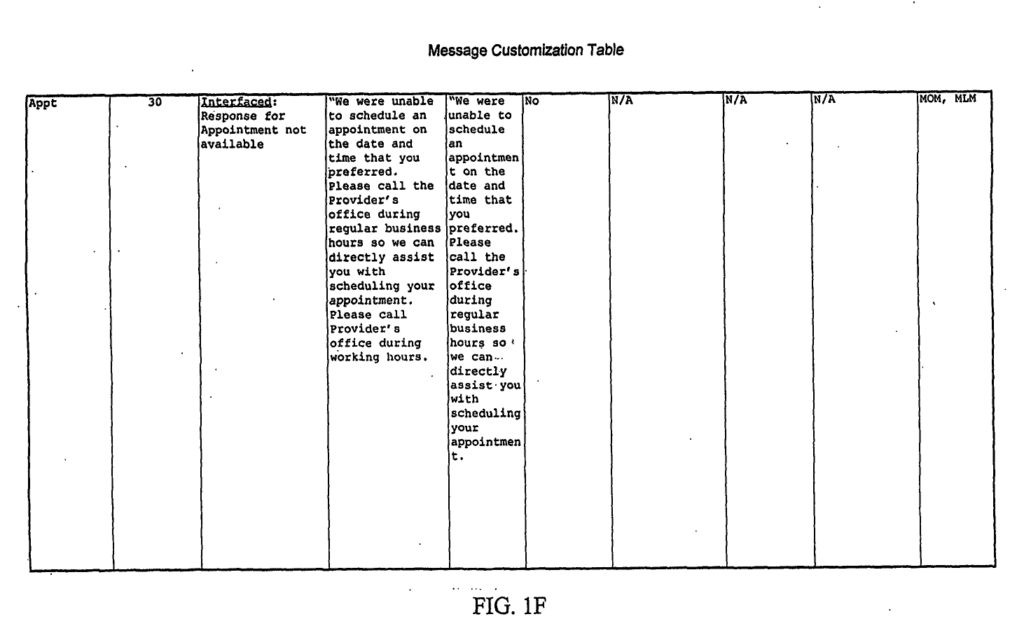

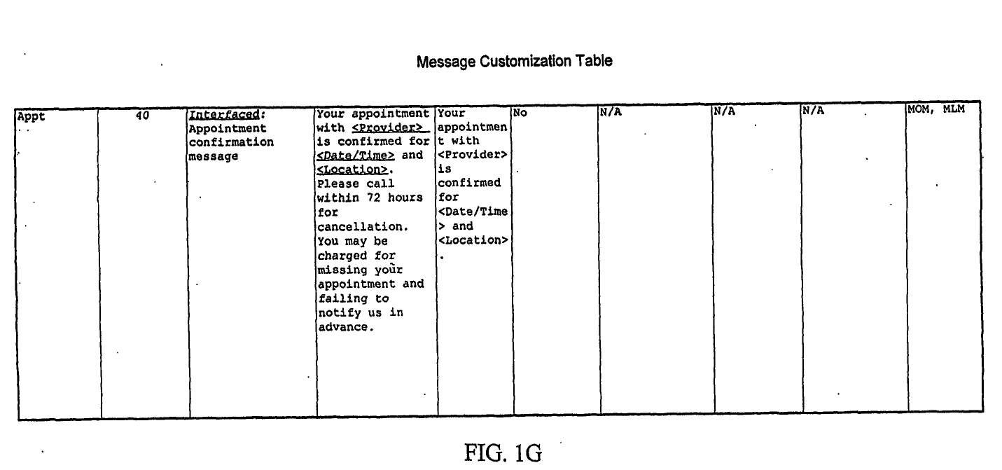

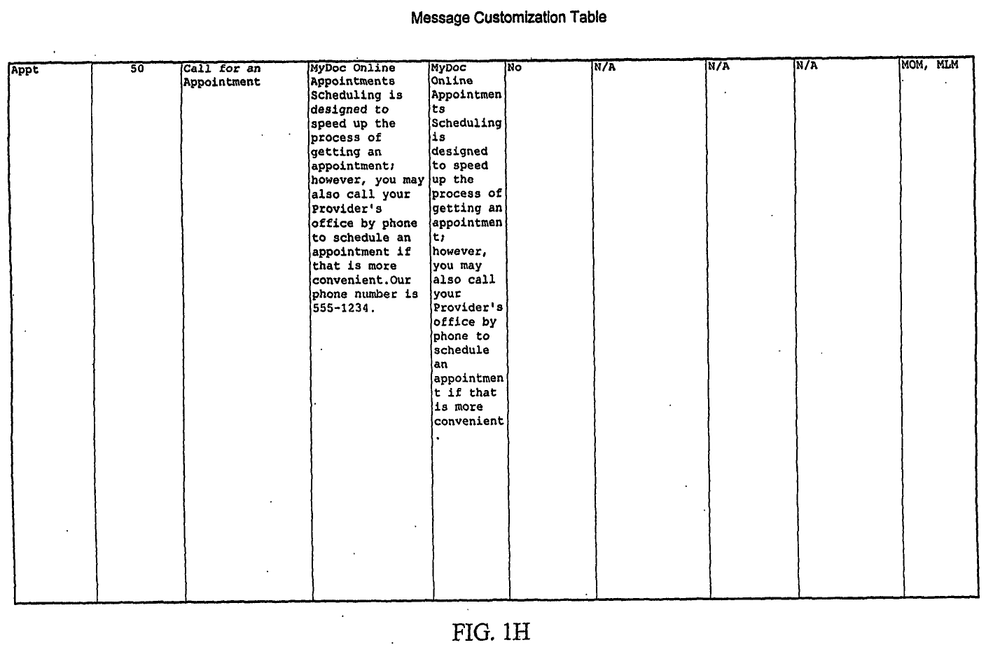

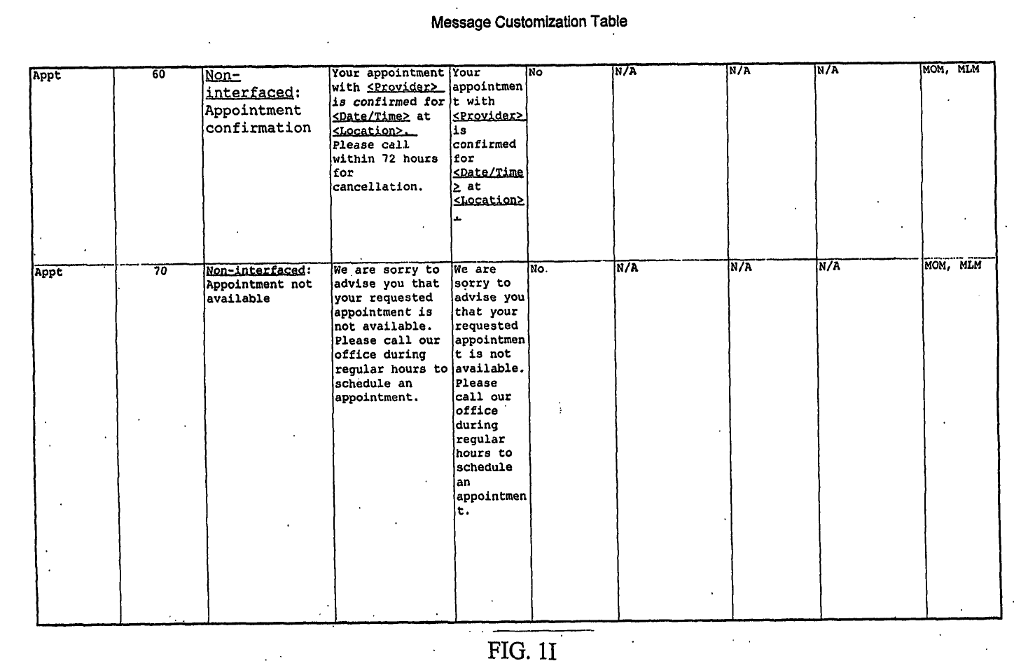

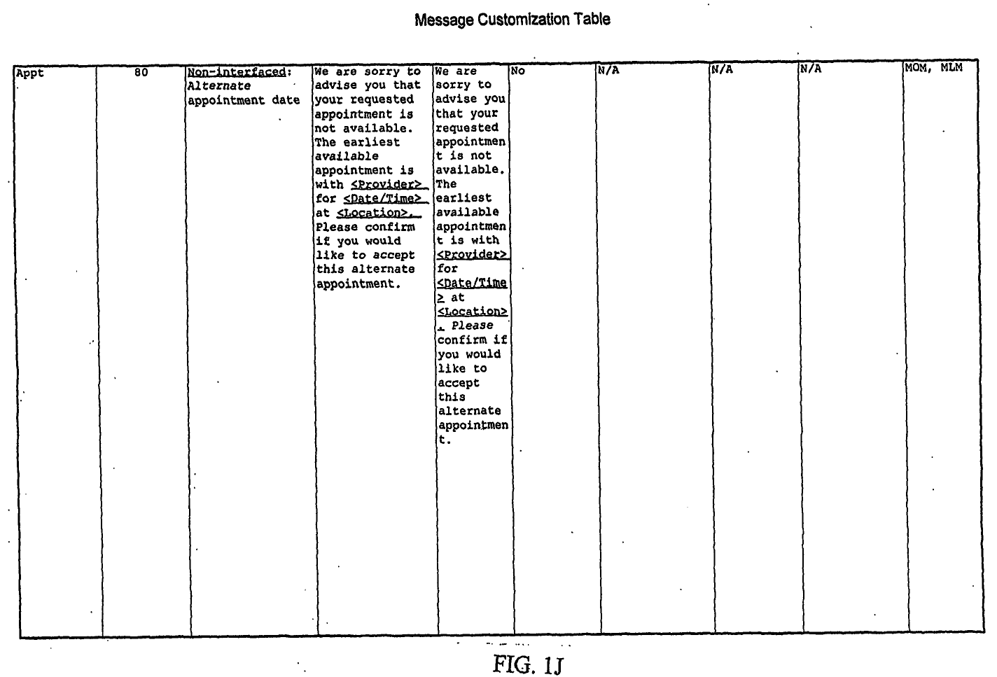

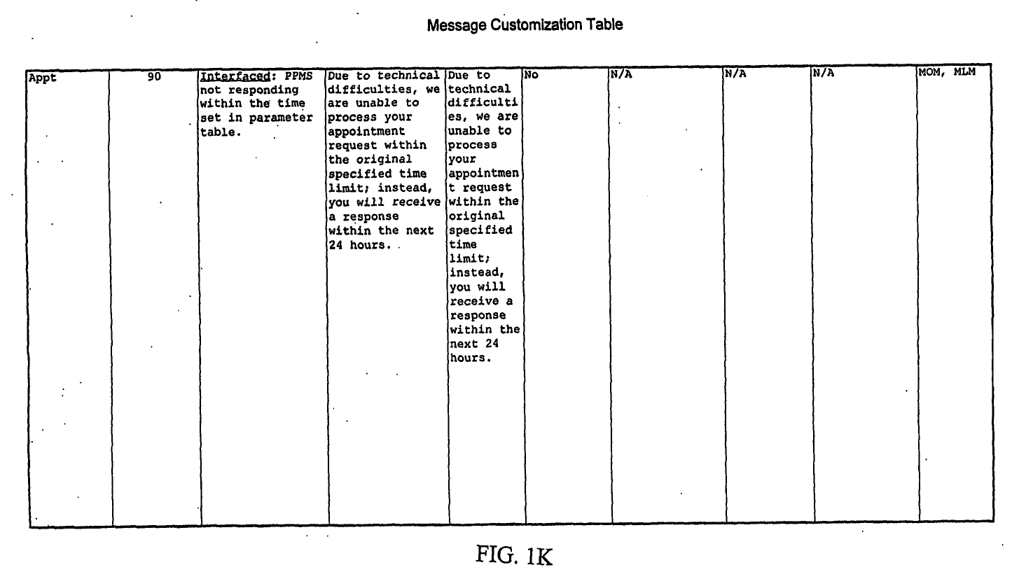

FIGS. 1A-1C show how the data relating to the customized section is stored in the MAT. Each medical provider has its own table entries. Each location, medical organization, and specialty may also have their own table entries.

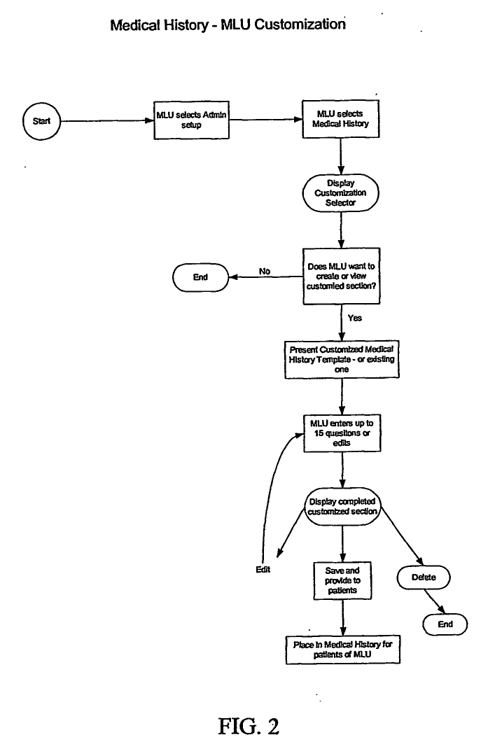

FIG. 2 shows a self-explanatory flowchart of the medical history customization process.

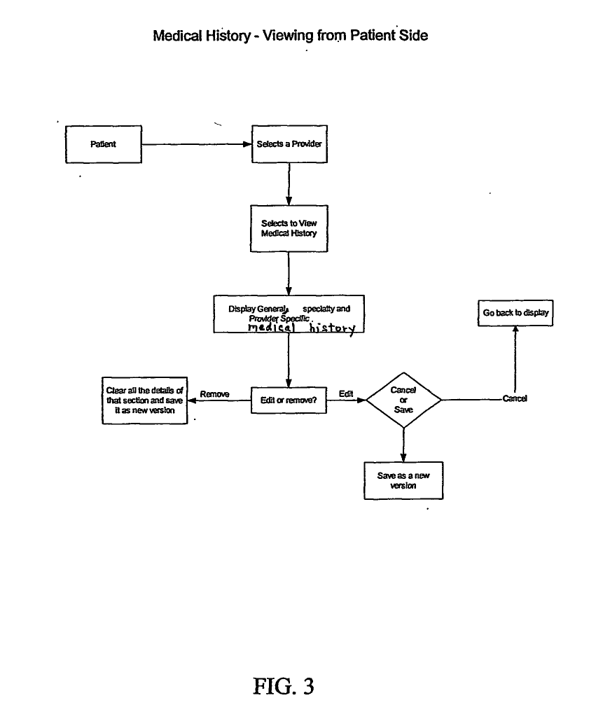

FIG. 3 shows a self-explanatory flowchart of the medical history process, as viewed from the patient side.

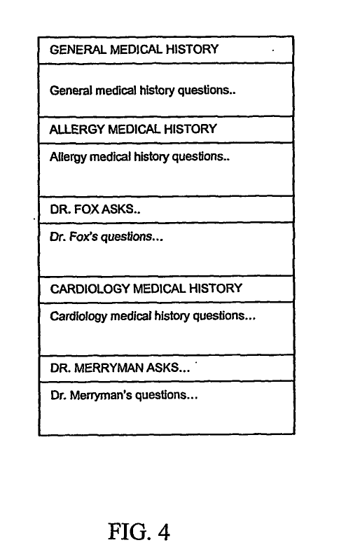

FIG. 4 shows the contents of a patient's medical history. When a patient is viewing his or her complete medical history, the general medical history is shown first, followed by the specialty medical history (if any), and the medical provider specific medical history. Consider the example of FIG. 4 wherein Dr. Fox is an allergy specialist and Dr. Merryman is a cardiologist. Patient Mom Jones has associated both of these medical providers with herself. If Mom Jones views her records, Dr. Fox's customized questions and answers, as well as Dr. Merryman's customized questions and answers become part of the medical history.

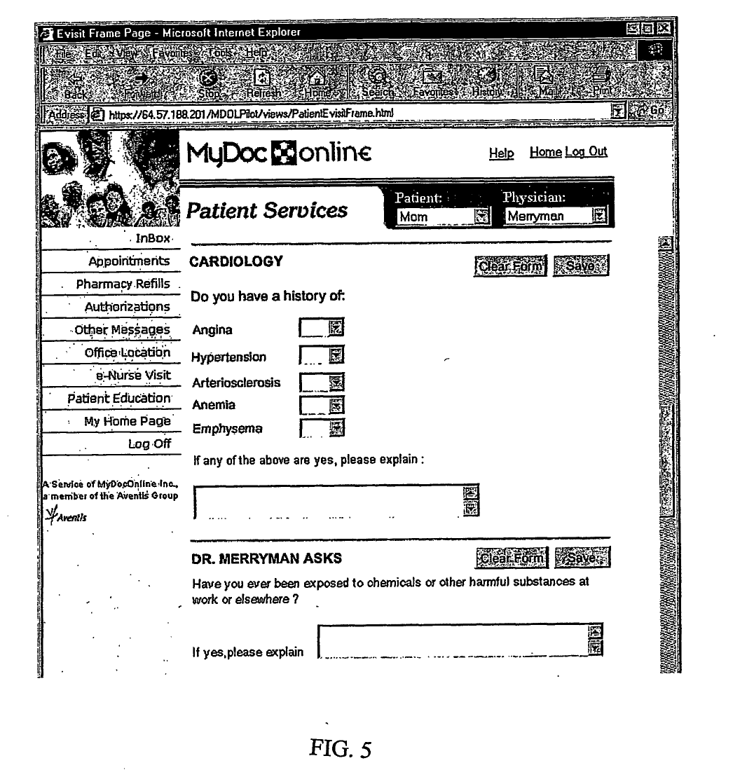

FIG. 5 shows a user interface screen which allows a patient (here, Mom Jones) to input a response to one of Dr. Merryman's preprogrammed customized queries. In this example, Dr. Merryman has chosen a free form text response type.

II. Patient appointments with interfaced and non-interfaced medical providers.

FIGS. 1D-1K show how the data relating to the interfaced and non-interfaced medical providers is stored in the MAT. Each medical provider has its own table entries.

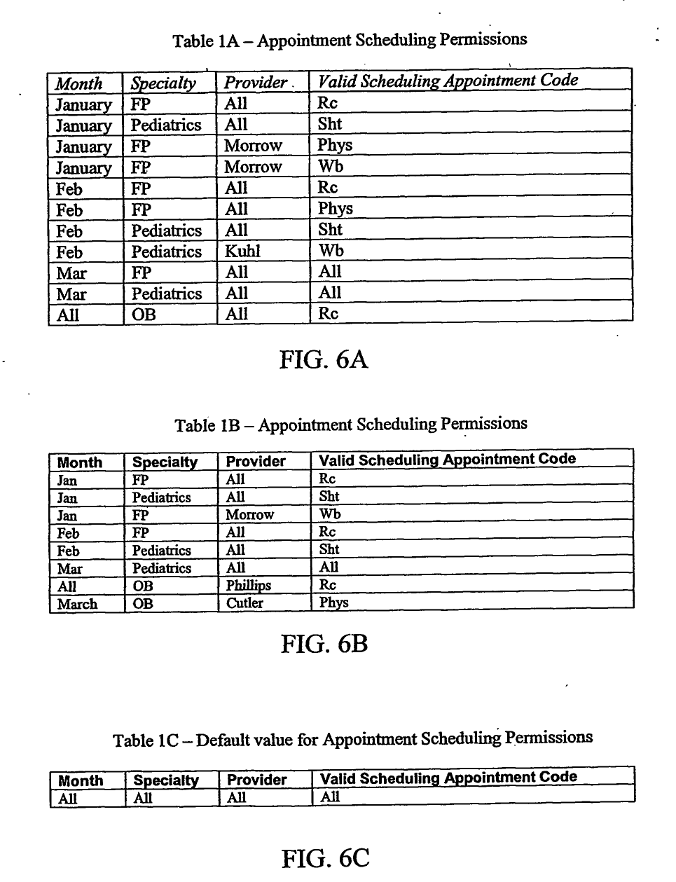

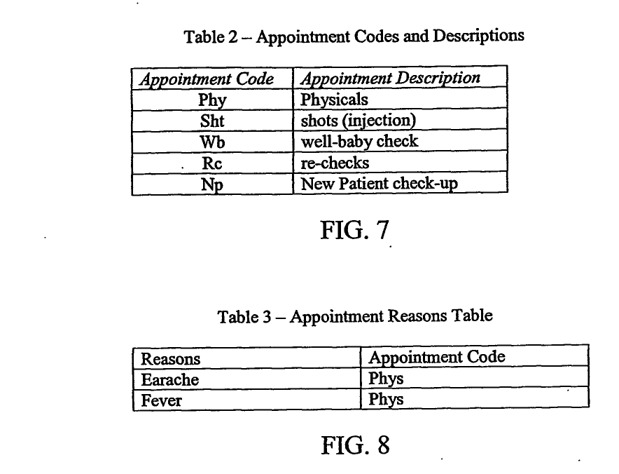

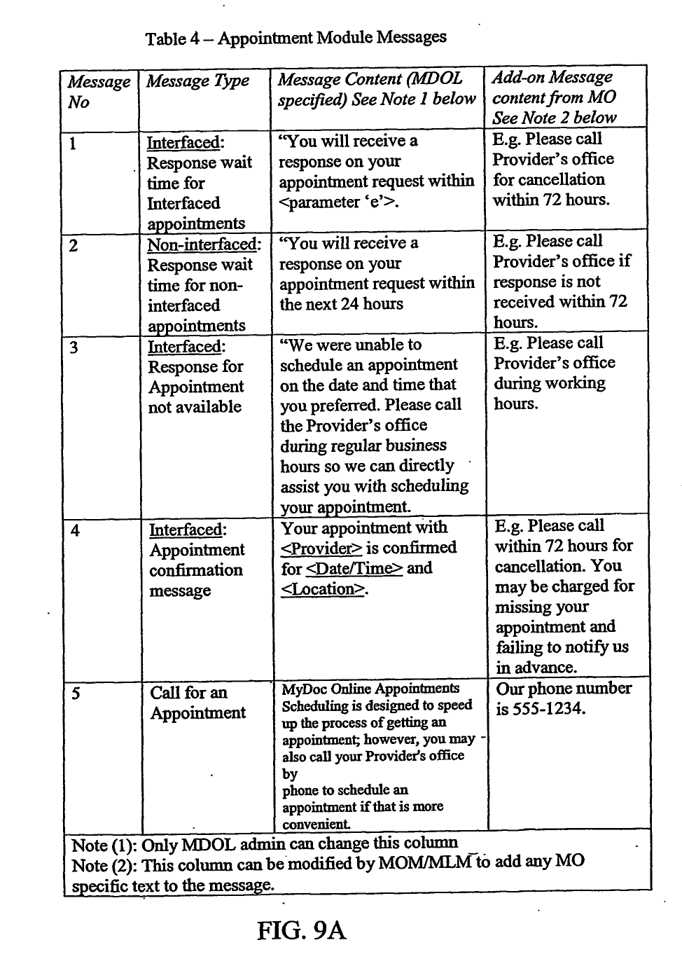

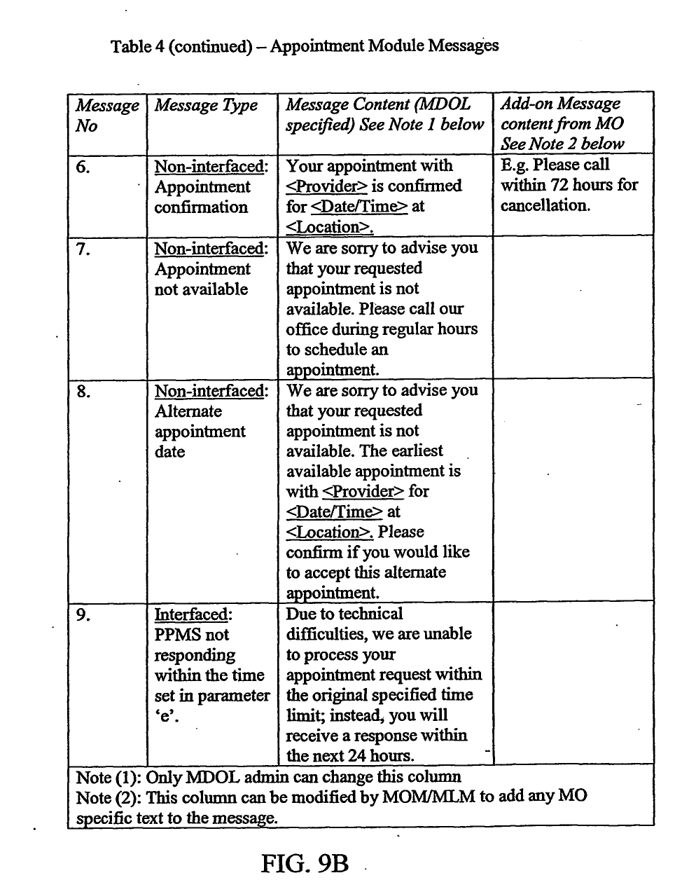

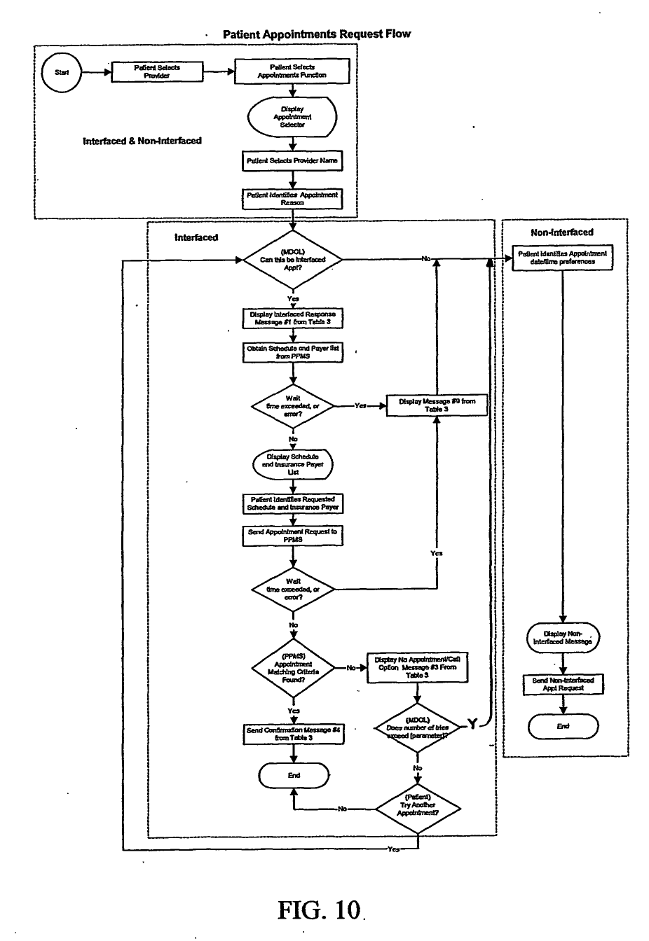

FIGS. 6A-6C are Tables 1A-1C, respectively, that shows appointment scheduling permissions. FIG. 7 is Table 2 that shows appointment codes and definitions. FIG. 8 is Table 3 that shows appointment reasons. FIGS. 9A-9B, taken together, is Table 4 that shows appointment module messages.

FIG. 10 is a flowchart of the patient appointment request process.

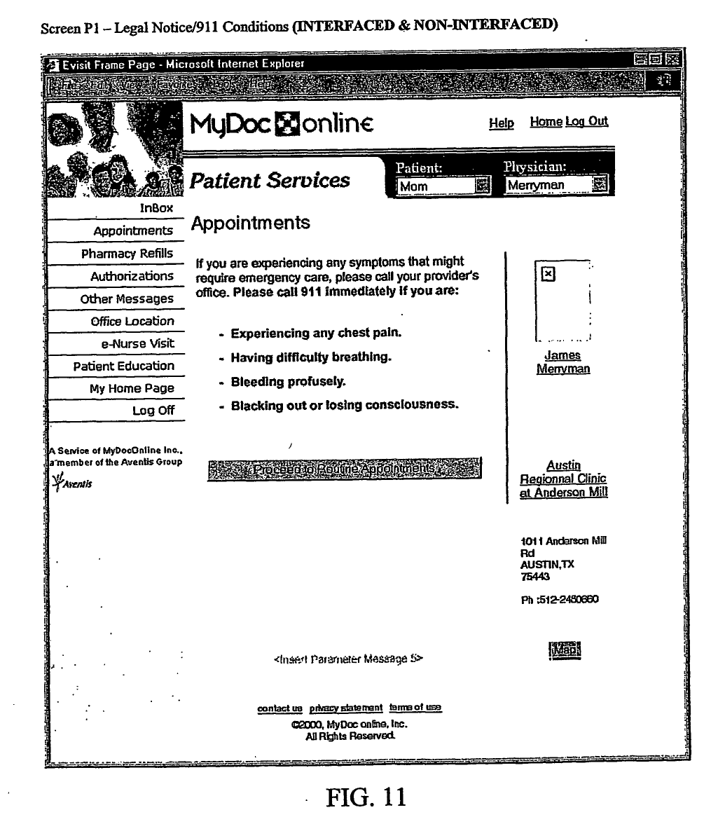

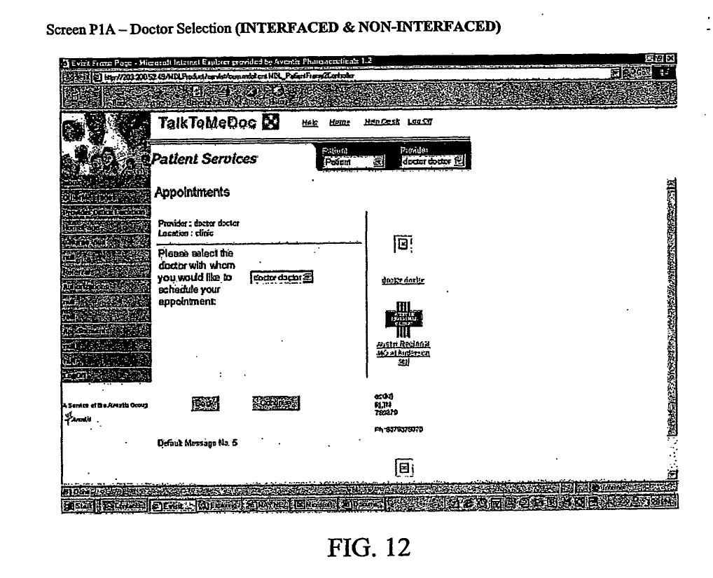

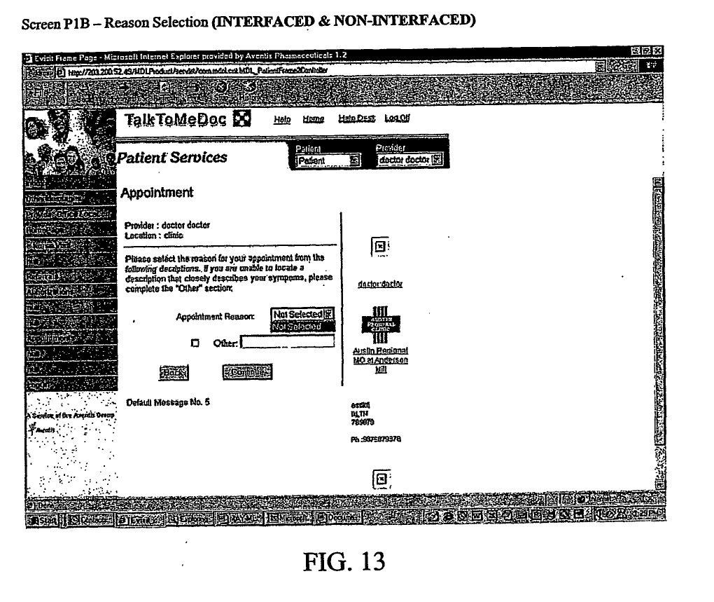

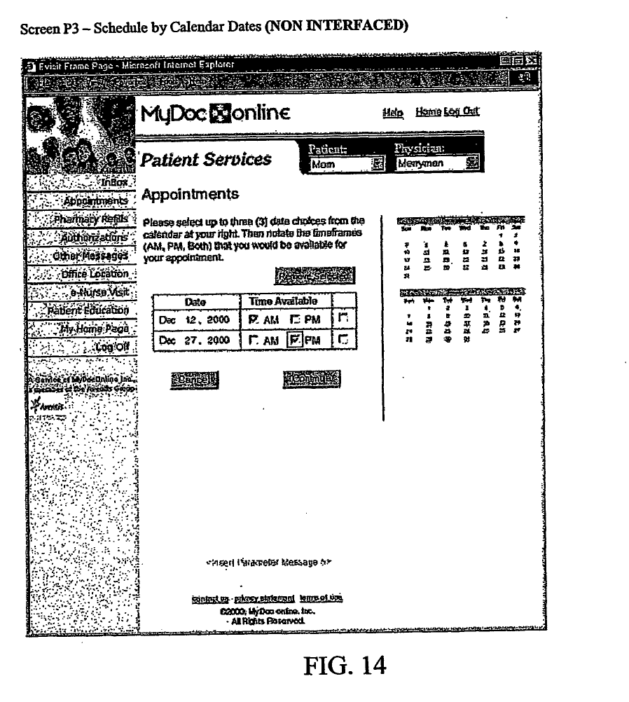

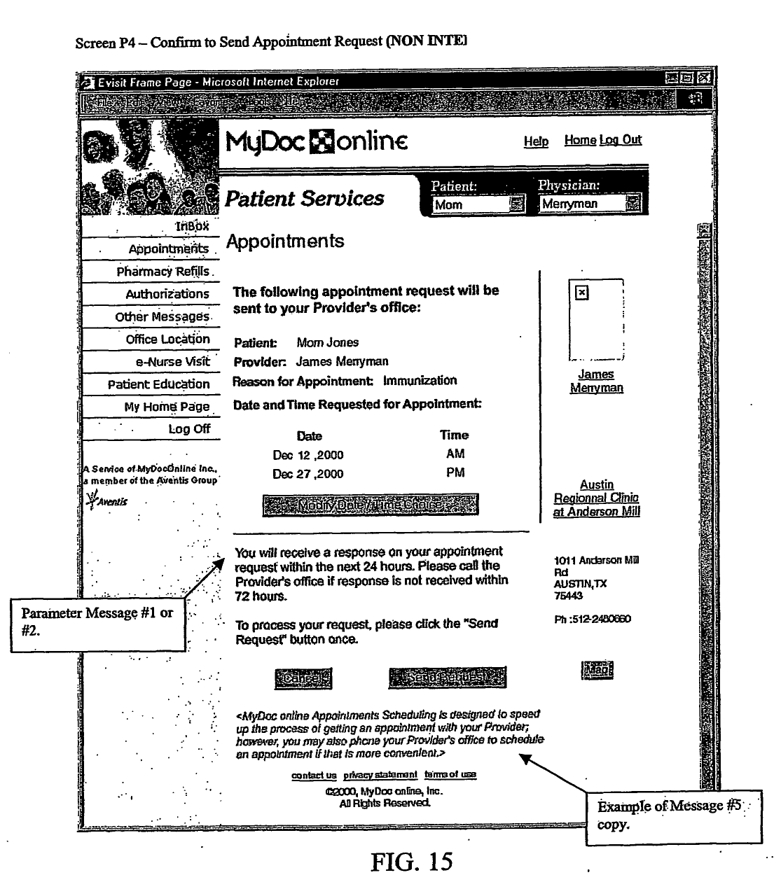

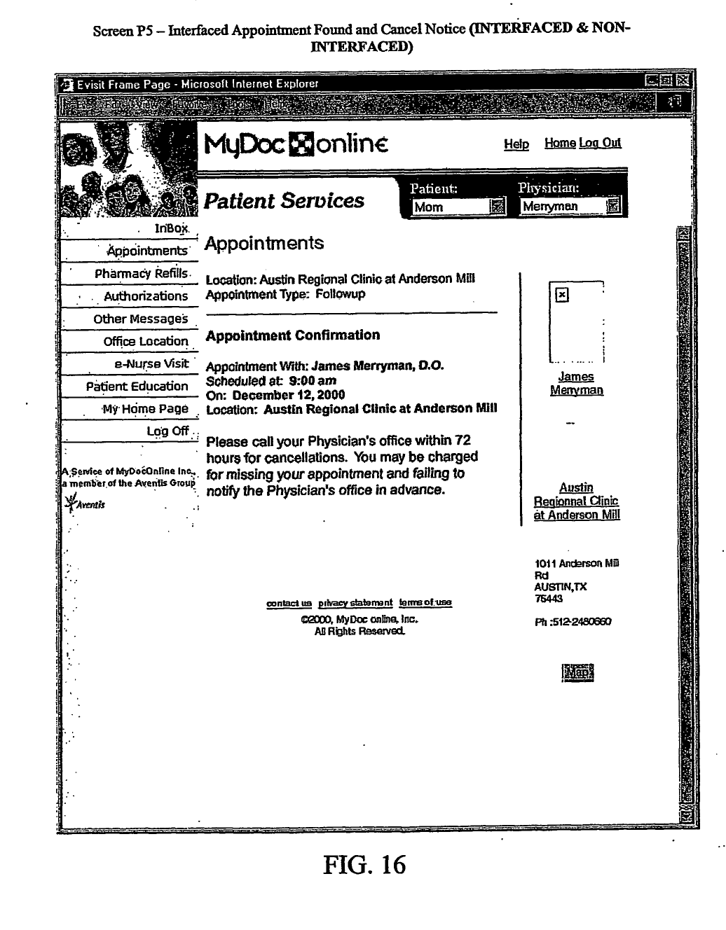

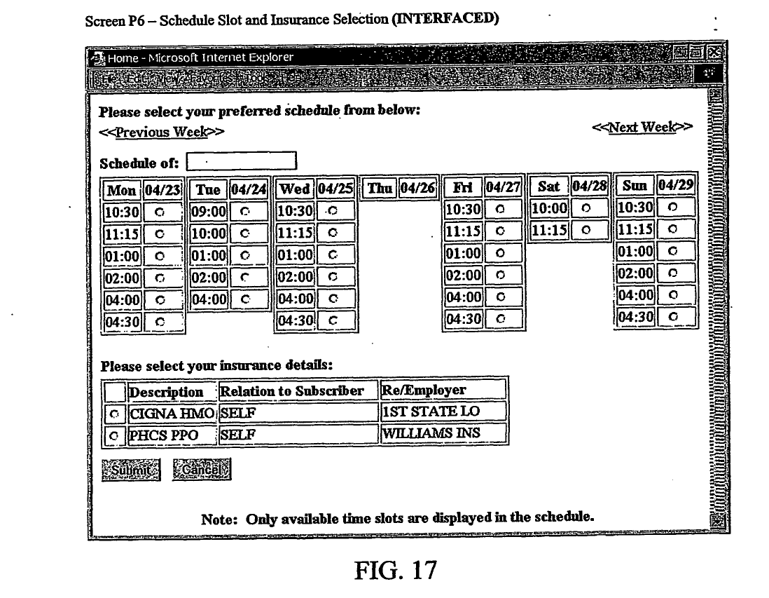

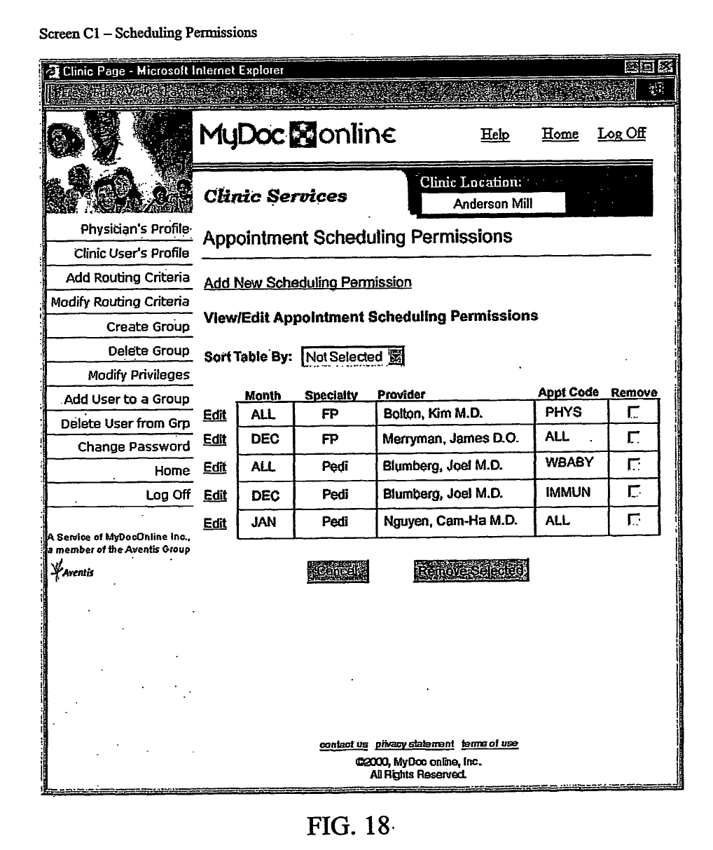

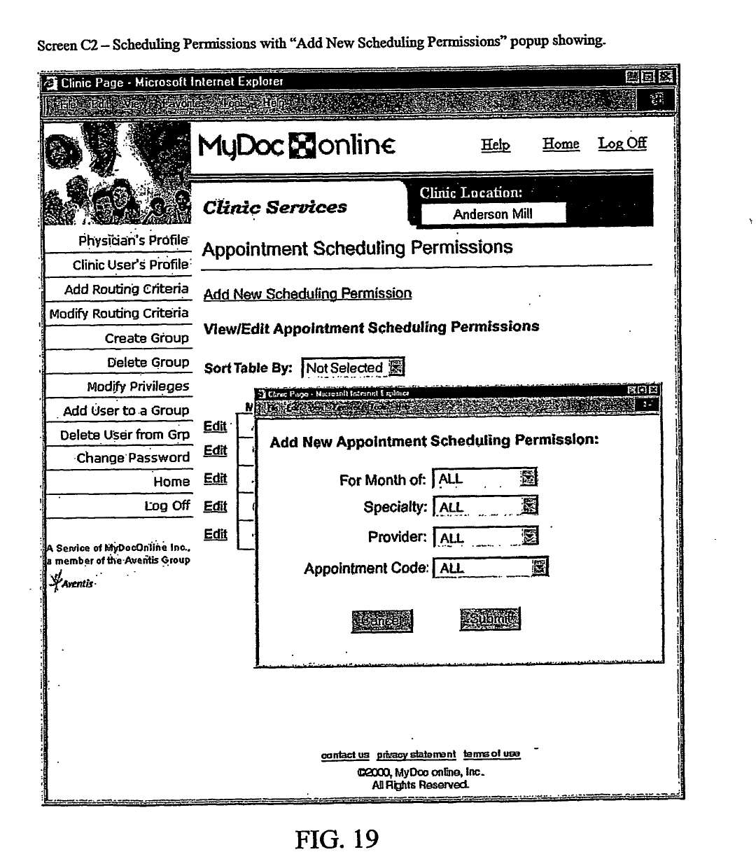

FIGS. 11-19 are screen shots of user interface displays experienced by patients and medical providers during the appointment scheduling process. “P” type screens (FIGS. 11-17) are for patient use, and “S” type screens (FIGS. 18-19) are for MO use.

The appointment scheduling process is described in software specifications below which reference the tables, flowchart and screen shots of FIGS. 6A-19.

Specifications:

1. Patients' Appointment requests are handled by MDOL, via PPMS Interfacing, or non-interfaced messaging.

a. Interfaced: An automated interface to the MO's PPMS system that MDOL can interface to. In this situation, communications and notifications to patients are synchronous, and real time appointments are supported. In order for this option to work, the MO must have the following:

i. Good network connection(s) between the MO and the MDOL application.

ii. A supported PPMS system.

b. Non-interfaced: Using the message based appointment system, where an Appointment request message is sent on behalf of the patient by MDOL to the ML user responsible for appointments. This method is used for cases such as the following:

i. The appointment system (PPMS) used by the MO cannot be interfaced from MDOL.

ii. MO does not have a PPMS system or has a PPMS system that MDOL cannot link to due to inadequate network connection and other such reasons.

c. A patient user will not be aware of whether or not their Provider's PPMS is interfaced to MDOL. The Appointment Request UI is identical. The MDOL internal logic determines which path to take (interfaced vs. non-interfaced), based on MO parameter settings and patient user input during the appointment scheduling session.

2. Maintenance of Internet Appointments Availability is performed through MDOL Admin UI: (See the UI screens (FIGS. 18 and 19) for “Appointment Scheduling Permissions”).

a. Month—This is a drop down list of the months in the year. “All” is an option which indicates all 12 months of the year. (Note: To keep the application and UI simple, the granularity of calendar is intentionally kept to the Month level, instead of days).

b. Specialty (drop down choice=All, FP, Internal Medicine . . . ). The drop down values are specific to the ML.

c. Provider (drop down choice=All, List of Providers). The drop down values are specific to the ML.

d. Valid Scheduling Appointment Codes

(drop down choice=All, phys, sht, wb, . . . etc.)

Refer to Table 2 in FIG. 7 (Table of Appointment Codes and Their Descriptions). These can be customized only by the MOM.

e. Appointment Description mapping to Appointment Code maintained by ML Manager. MDOL provides the default entries and values for Table 2.

f. Parameter Driven Messages—For messages used in this module that can be customized, see FIGS. 9A-9B, Table 4 (Table of Appointment module messages).

g. Table 1A: Appointment Scheduling Permissions:

This is an internal table of Internet Appointments Available, built by MDOL application based on customization by the MLM using the UI Screen for “Appointment Scheduling Permissions”.

Adding a Provider into the table “tuns that Provider to ON” for taking internet-booked appointments for the specified appointment codes.

The MLM at each ML is privileged to make entries into this table.

In the above example, for the month of January, All family practice (P) Providers at this location are taking internet-booked appointments for only the appointment code “rc” (re-checks), except for Dr. Morrow, who is also taking internet-booked appointments for appointment code “phys” (physicals). Adding Dr Morrow here indicates an ‘additive’ effect that Dr Morrow can provide Physicals and Well-baby appointments “in addition to” Re-checks that are provided by all FP Providers at the ML. All Pediatric Providers are taking internet-booked appointments for only “shf” (shots) appointment code.

For the month of February, all FP Providers at the location are taking internet-booked appointments for both “rc” and “phys” appointment codes. All Pediatrics Providers are taking internet-booked appointments only for the “sht” appointment code, except for Dr. Kuhl who is also (additive) allowing internet-booked appointments for “wb” (well-baby checks).

For the month of March, all FP and Pediatrics Providers at this location are accepting internet-booked appointments for all appointment codes.

Finally, All OB Providers can accept internet appointments for Re-checks for ALL months of the year.

3. Parameters Relative to this module:

a Interfaced Appointments Enabled Parameter: A system (MO wide) defined parameter for enabling and disabling the interfaced system for fulfilling automated Appointment requests from MDOL to the MO's PPMS system via internet. The default value for this parameter is “Disabled”. Only the MOM can change the value of this flag from Disable to Enable and back. Changes to the value of this parameter are effective only for future actions and are not retroactive.

b. Maximum number of Interfaced Appointment Retries: This parameter indicates “Number of retries an interfaced appointment should be attempted before the appointment request is automatically switched to a non-interfaced appointment request message”. The default value for this parameter is 3 and can be customized by the MOM/MLM.

c. Table of Appointment codes and their Descriptions: This parameter table maps Appointment Descriptions to Appointment Codes. Only MOM can alter this table (add, delete and update). The default mode provided by MDOL is to allow the MOM to customize this table (i.e. the table is Unlocked). These codes are not expected to change often and MLMs should not alter this table. MDOL will provide a default set of Appointment codes. Table 2 is a sample set of Appointment Codes and Descriptions.

Note: In Table 2, the Appointment code can be up to 6 chars alphanumeric. Appointment Description is a text field up to 50 chars in length. There can be any number of Appointment codes in this table.

Table 3: Appointment Reasons Table

This table is maintained by the M in order to provide more meaningful choices for the patients in selecting the Appointment Descriptions. There is a direct mapping within an appointment code and appointment descriptions AND a reason and appointment code. Ultimately, it is the appointment code that is important because this is the field that ties in to the PPMS.

d. Duration MDOL application waits for response from PPMS: The default value for this parameter is 60 seconds. A preset display message is sent if the timeout value is reached. MDOL Admin sets the maximum duration and MOM can reduce this duration to a lower limit or can increase this duration to a higher limit.

e. Table 4 shows Appointment module related messages which can be customized by the MOM or MLM.

4. Transaction Flow for Appointment request from Patient:

(NOTE: The text below gives a high-level flow and is complemented by the flowchart in FIG. 10 and UI screens (FIGS. 11-16).

a. Patient must have selected a Primary Provider before the Appointment item in the menu is enabled. When the Patient selects the Appointment item in the menu, the functionality described below is executed.

b. Patient can select an alternate Provider. This allows the Patient to schedule an appointment with another Provider. The default is the Primary Provider selected above in step “a.”

c. Patient identifies Appointment reason desired using a drop down menu. If the desired Appointment is not in the drop down menu, the patient should select ‘Other’ and enter text to indicate the preferred Appointment. Note (1): MDOL maps available Appointment Codes (From Table 1A) to Appointment Reasons for display to the, patient in the drop down menu and sends the selected Appointment code in the Appointment request to the PPMS. Note (2): If the Patient selects ‘Other’ and enters an Appointment description, this appointment request is sent as a non-interfaced message to the ML's Appointment common inbox.

d. At this point, MDOL has all of the information needed to determine the scheduling path (interfaced or non-interfaced). To the extent possible, MDOL should use the interfaced path to schedule an appointment.

e. However, a number of conditions will make interfaced scheduling of appointments not work, and instead, will (automatically/transparently) invoke the non-interfaced (via message to ML) MDOL logic. The conditions which will invoke the non-interfaced logic are:

1. Interfaced Appointments Enabled Parameter=“N”

OR

2. The patient has selected ‘Other’ option in Appointment type drop down menu (in other words, the appointment type is not in Table 2 (Table of Appointment Codes and Their Descriptions)

OR

3. Provider is not in Table 1A (Table of Appointment Scheduling Permissions) AND the patient is not willing to schedule with alternate Provider.

OR

4. Preferred dates are not in Table 1A (Table of Appointment Scheduling Permissions) for the Provider AND the patient is not willing to schedule with alternate Provider.

OR

5. Appointment Code not in Table 1A (Table of Appointment Scheduling Permissions) for the Provider, for the preferred dates AND the patient is not willing to schedule with alternate Provider.

OR

6. The number of attempts to schedule via the PPMS interface has equaled the Maximum number of Interfaced Appointment Retries Parameter.

5. Non-interfaced Appointments.

Transaction Flow for Request From Patient:

a Patient identifies preferred date and time for the desired Appointment in one of several ways:

i. Indicating any first available appointment with the provider

ii. Selecting preferred day(s) of the week and selecting AM or PM

iii. Using a calendar from which to select preferred appointment dates. Patient selects preferred 3 days, and makes AM/PM selections.

b. Display [Message #5 in Table 4 (Table of Appointment module messages)].

c. Patient receives [Message # 2 in Table 4 (Table of Appointment module messages)].

d. MDOL routes the appointment message to the MLU, based on MDOL security, routing and privileging criteria.

e. Demographic and insurance information is attached to the message.

Transaction Flow for Response to Patient:

a. MLU receives appointment request from personal inbox or common tray.

b. If the Patient has authorized delivery of their Medical History Form, then the MLU is given the option to view and/or print the patient's Medical History Form; otherwise, a message is displayed that indicates that the patient has not authorized the release of their personal Medical History Form.

c. MLU attempts to book the appointment in the MO's PPM (manual or automated)—Note: This is a non-MDOL step which is noted here only for process clarification.

d. Accept an entry from the MLU that indicates whether or not an appointment was successfully booked.

e. If an appointment was successfully booked, then the MLU creates a response to the patient, as follows:

i. MO enters the appointment details into the appointment response template: “Your Appointment with <provider>is confirmed for <date/time>, at <location>.”

ii. Display [Message # 6 in Table 4 (Table of Appointment module messages)].

f. If an appointment was not successfully booked, then the MLU creates a response back to the patient suggesting an alternative date/time or an alternative method for scheduling the appointment, as follows:

Allow the option to include ANY/ALL of the following messages in the MLU response to the patient:

i. Display [Message # 7 in Table 4 (Table of Appointment module messages)]. (for example, this message might simply explain that the requested date/time was not available)

ii. Display [Message # 8 in Table 4 (Table of Appointment module messages)].—allow drop down selection of day, date, time.

iii. Display [Message # 9 in Table 4 (Table of Appointment module messages)]. (for example, this message might give the appointment clerk's phone number)

g. Send the MLU response to the patient.

Transaction Flow for Confirmation from Patient:

If the MLU had suggested an alternative date/time as described above, then allow the patient to accept/decline the alternative with yes/no response. Send the yes/no response back to the MLU.

6. Interfaced appointments

a. Patient receives [Message number 1 in Table 4 (Table of Appointment module messages)]. Display hourglass to show request is in progress.

b. At this point, MDOL communicates to the PPMS system via the automated interface. MDOL requests the Schedule of available time slots for the selected Provider, and a list of the Insurance Plans for this patient.

c. The automated PPMS interface always returns two (2) months, or less of the Schedule of available time slots for the selected Provider.

d. MDOL checks for the elapse of parameter ‘d’ while waiting for response from the PPMS system. If this timer elapses, then MDOL will Display Message #9 and proceed to the Non-interfaced path (before the “Patient identifies Appointment date/time preferences” since none has been specified).

e. MDOL will display the Schedule of available time slots and the VIsurance Payer list.

f. The Patient will identify the requested schedule and their Insurance Payer.

g. At this point, MDOL communicates to the PPMS system again using the automated interface. MDOL submits the requested appointment.

h. MDOL will check for the elapse of parameter ‘d’ while waiting for response from the PPMS system. If this timer elapses, then MDOL will Display Message #9 and proceed to the Non-interfaced path (after the “patient identifies Appointment date/time preferences” since date/time has already been specified).

i. If the appointment request was successful, MDOL will send Confirmation Message #4 from Table 4 and end.

j. If the appointment was unsuccessful, MDOL does several things:

i. Create an entry in the Audit trail to indicate the Appointment request to the PPMS was not successful. This will help with Appointments usage report and indicates which Patient Appointment requests failed.

ii. Present [Message #3 from Table 4]

iii. Check to see if the parameter “Max number of Interfaced Appointment Retries” has been exceeded. If yes, then end.

iv. MDOL offers the Patient the opportunity to try another Appointment. If No, then end. If Yes, then restart at step “a,” above.

7. Appointment Scheduling Permissions Table: An important features of the appointment module is the previously described Appointment Scheduling Permissions table. FIG. 1B provides an example of this table, labeled as Table 1B. Table 1B is similar to Table 1A. A detailed explanation of the contents of Table 1B is provided below.

Row 1: All the providers of Family Practice specialty are doing re-checks (Rc) through out the month January.

Row 2: All the providers of Pediatrics specialty are doing Shots (Sht) throughout the month January.

Row 3: Only Dr. Morrow of Family Practice specialty is doing Well baby check (Wb) throughout the month January.

Row 4: All the providers of Family Practice specialty are doing re-checks (Rc) throughout the month February.

Row 5: All the providers of Pediatrics specialty are doing Shots (Sht) throughout the month February.

Row 6: All the providers of Pediatrics specialty are doing All kinds of appointments throughout the month March.

Row 7: All the providers of Obstetrics (OB) specialty are doing re-checks (Rc) throughout the months of January, February and March.

Row 8: Only Dr. Cutler of Obstetrics (OB) specialty is doing Physicals (Phys) throughout the month March.

8. How to relate the Table 1B Appointment Scheduling Permissions with the Transaction Flow for Appointment request from Patient (section 4 above): Consider the following example:

a. The patient is Mom Jones.

b. She has selected Dr. Phillips who is of Obstetrics specialty.

c. She also checked the box, which says that she is ready to meet an alternative provider.

d. Now when she wants to select her appointment, the drop down box containing appointment descriptions will be context sensitive.

e. From the table, it can be seen that in the specialty of OB, only two entries are shown (row 7 and 8). (Also, check if the specialty is mentioned as ‘All’ in the second column, since ‘All’ also includes Obstetrics.)

f. Only Dr. Philips and Dr. Cutler are listed as OB providers in the table.

g. Although Mom Jones is seeing Dr. Philips, since she has agreed to see an alternative provider, we have to consider Dr. Cutler as well.

h. Now see what all appointments are given by these two providers.

i. This search gives us two kinds of appointments: Rc and Phys. So, the appointment description combo box will have two entries which are:

i. Re-check

ii. Physicals

j. Mom Jones selects Re-check.

k. According to the Table 1B Re-check appointments are given through out the months of Jan, Feb and Mar.

1. From these dates, Mom Jones can pick up any three of her choice and try to set an appointment.

The default value provided by MDOL administrator for the Table 1A or 1B is shown in Table 1C. The default value indicates: all providers of all specialties of a location are providing all appointments. This is changed ONLY when either MOM or MLM customizes this table using the “Appointment Scheduling Permissions” UI.

III. Broadcast Messaging.

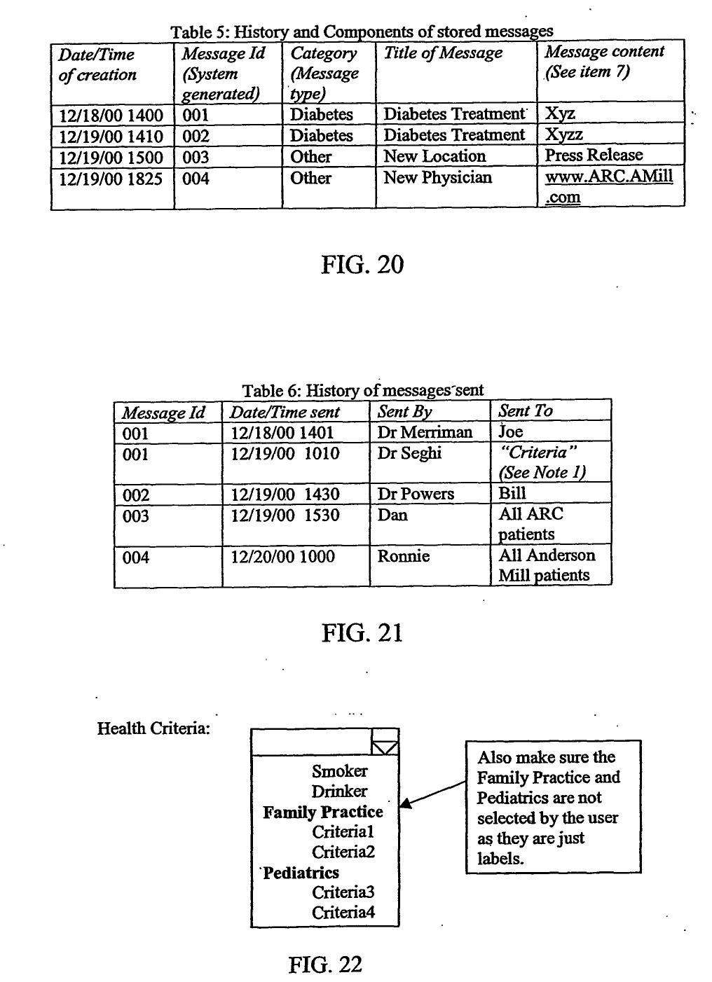

FIG. 20 is Table 5 that shows history and components of stored messages. FIG. 21 is Table 6 that shows history of messages sent. FIG. 22 shows a dropdown box of a user interface for selecting health criteria of a message.

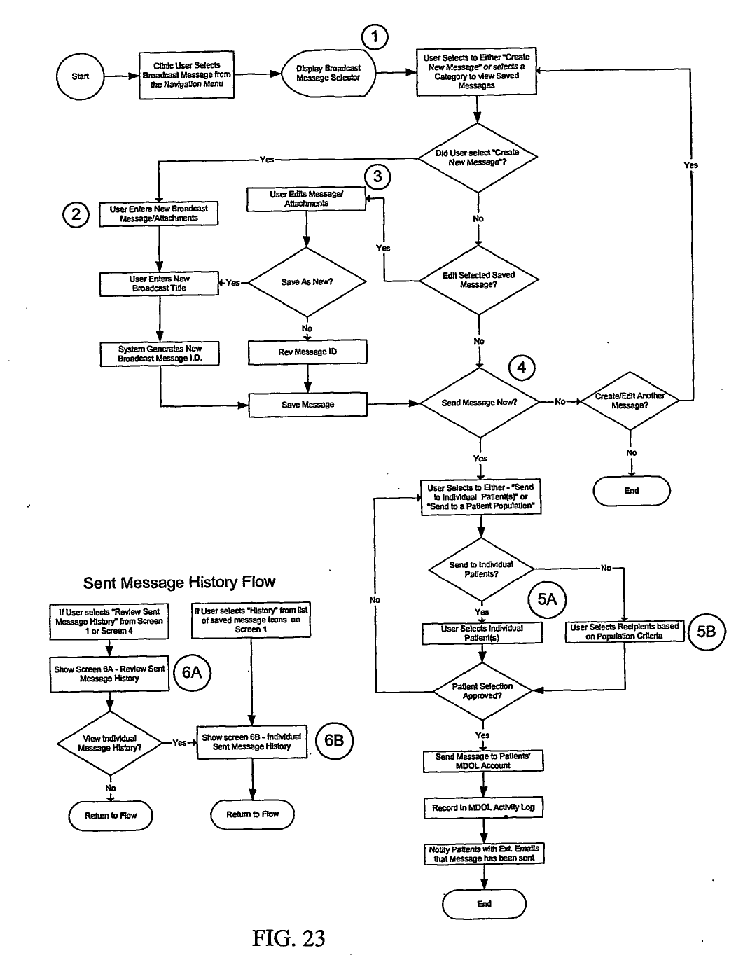

FIG. 23 is a flowchart of the broadcast messaging process.

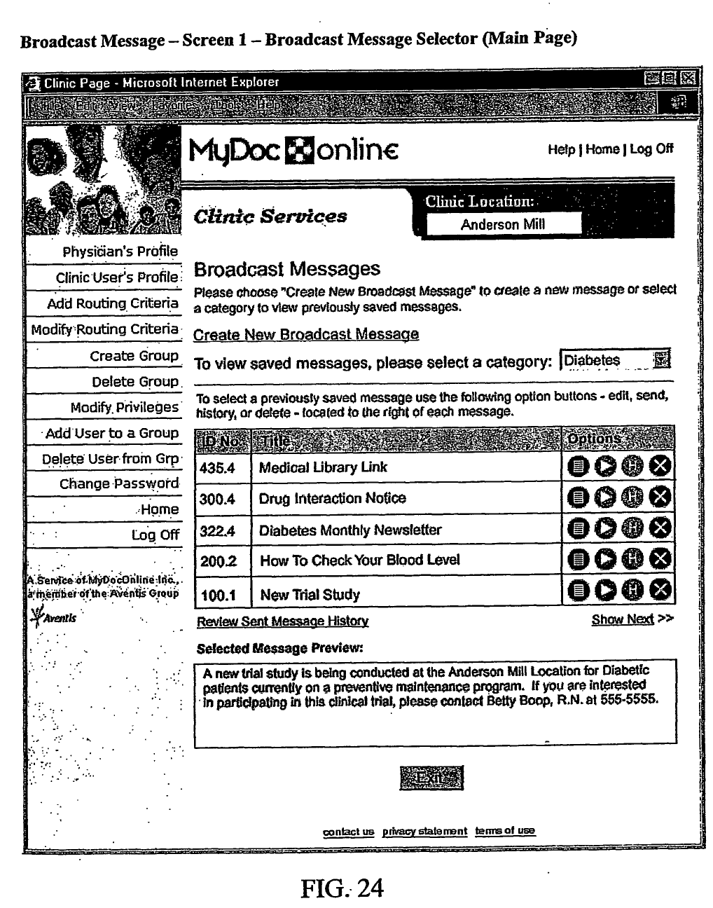

FIGS. 24-32 are screen shots of user interface displays for implementing broadcast messaging. FIGS. 24-32 correspond to screens discussed below as follows:

FIG. 24—Screen 1

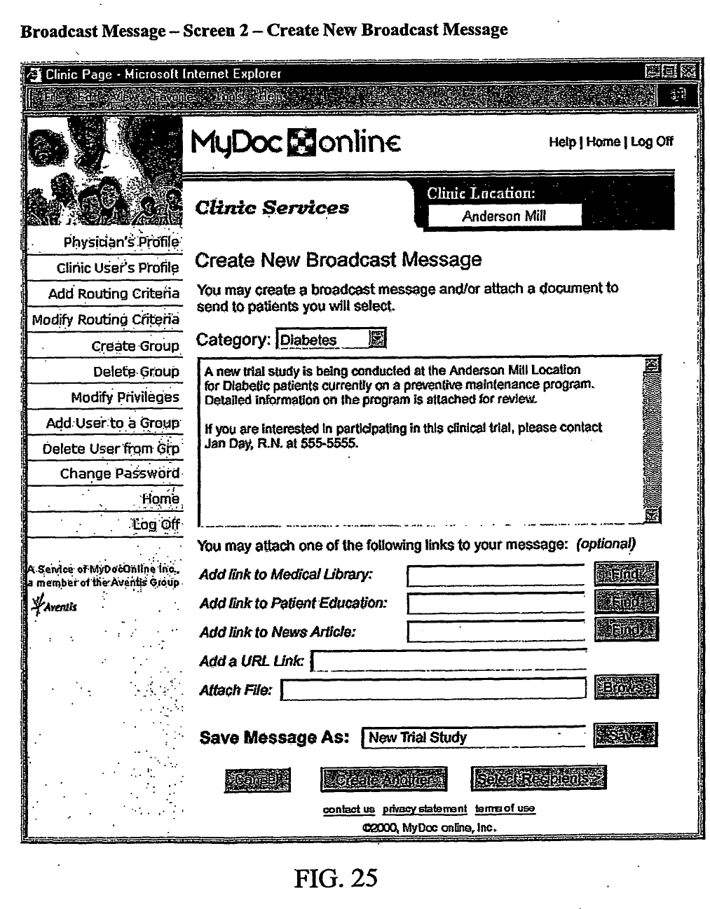

FIG. 25—Screen 2

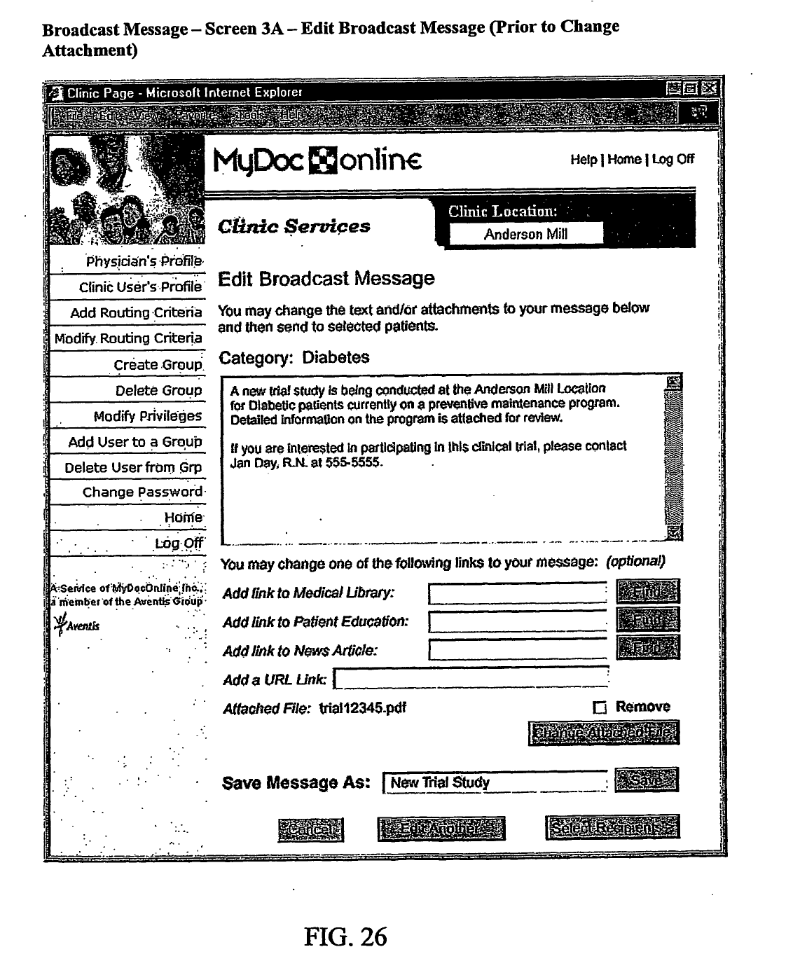

FIG. 26—Screen 3A

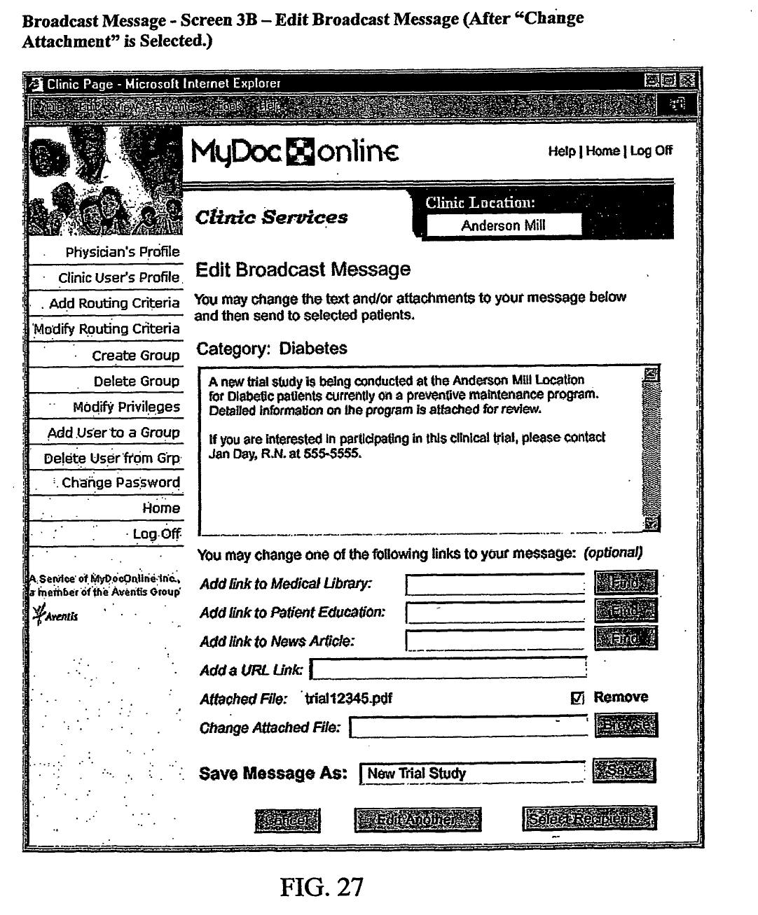

FIG. 27—Screen 3B

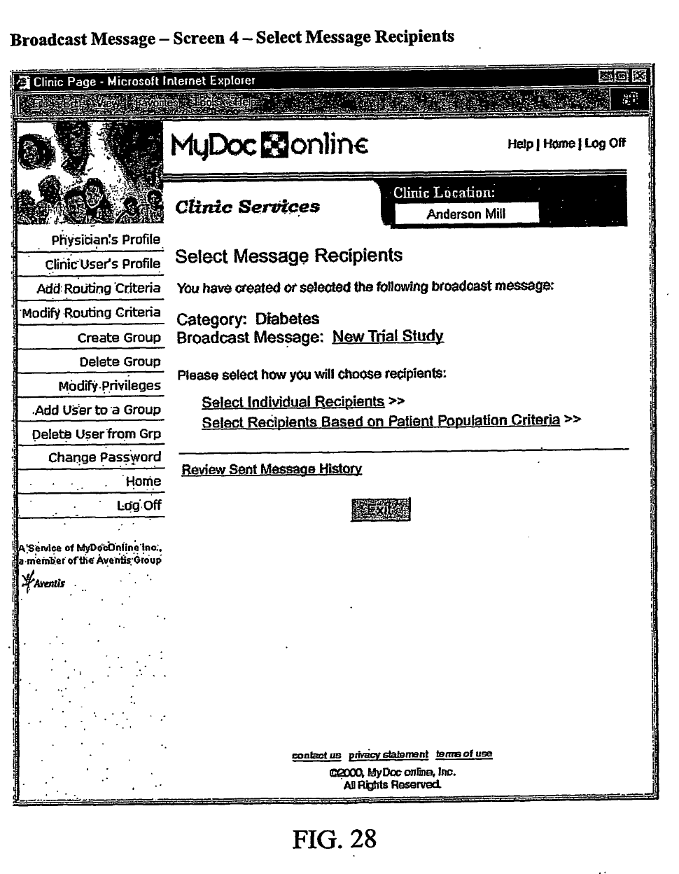

FIG. 28—Screen 4

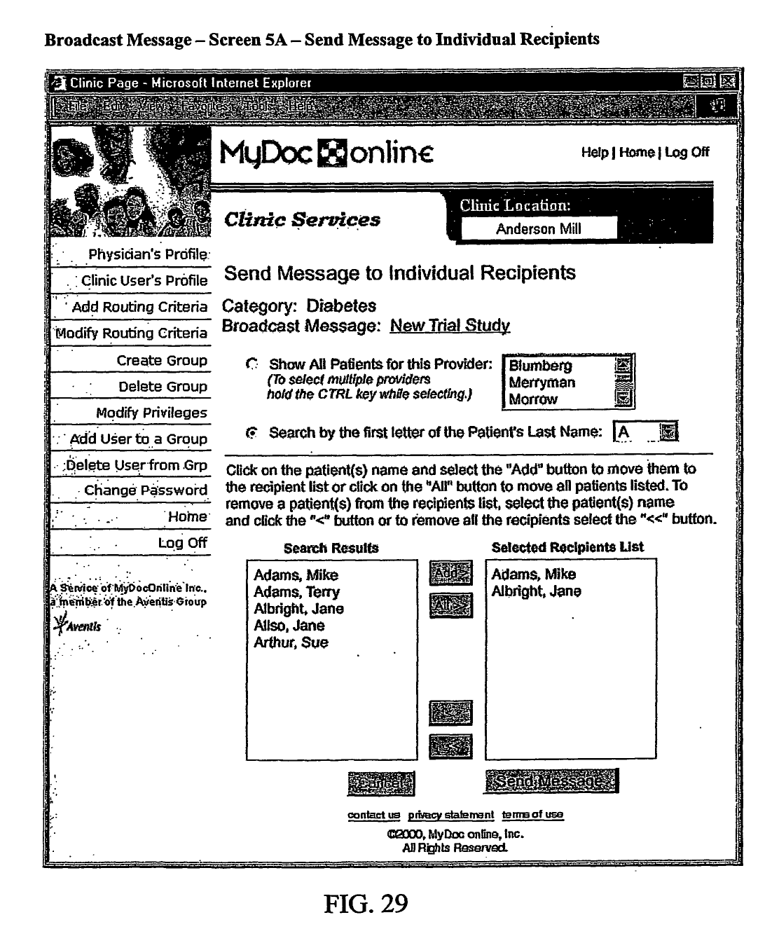

FIG. 29—Screen 5A

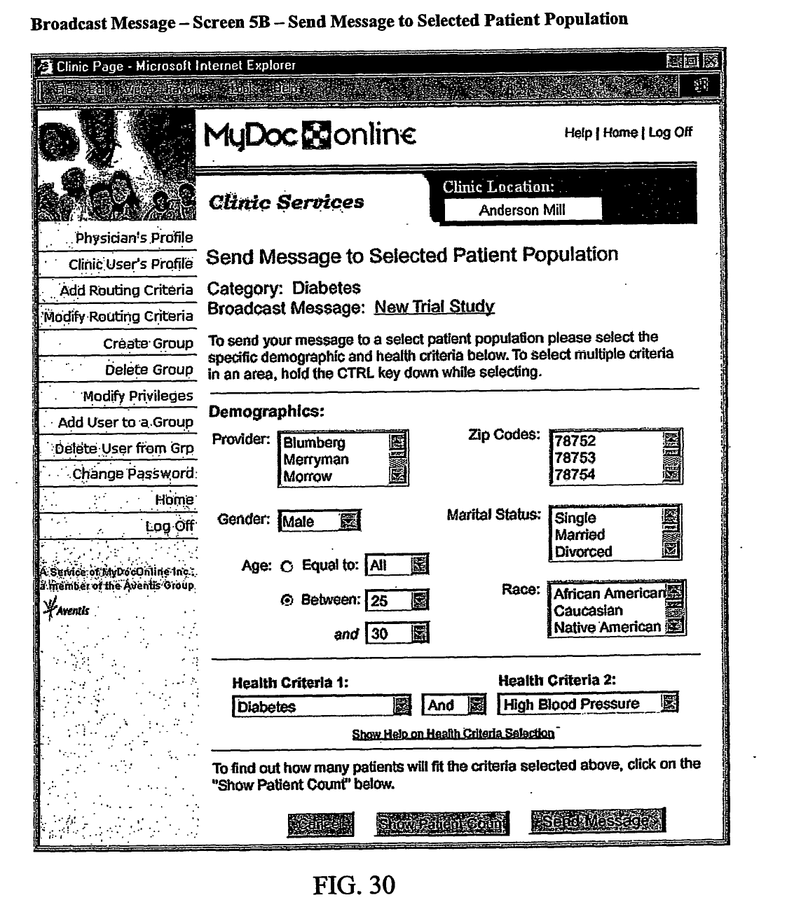

FIG. 30—Screen 5B

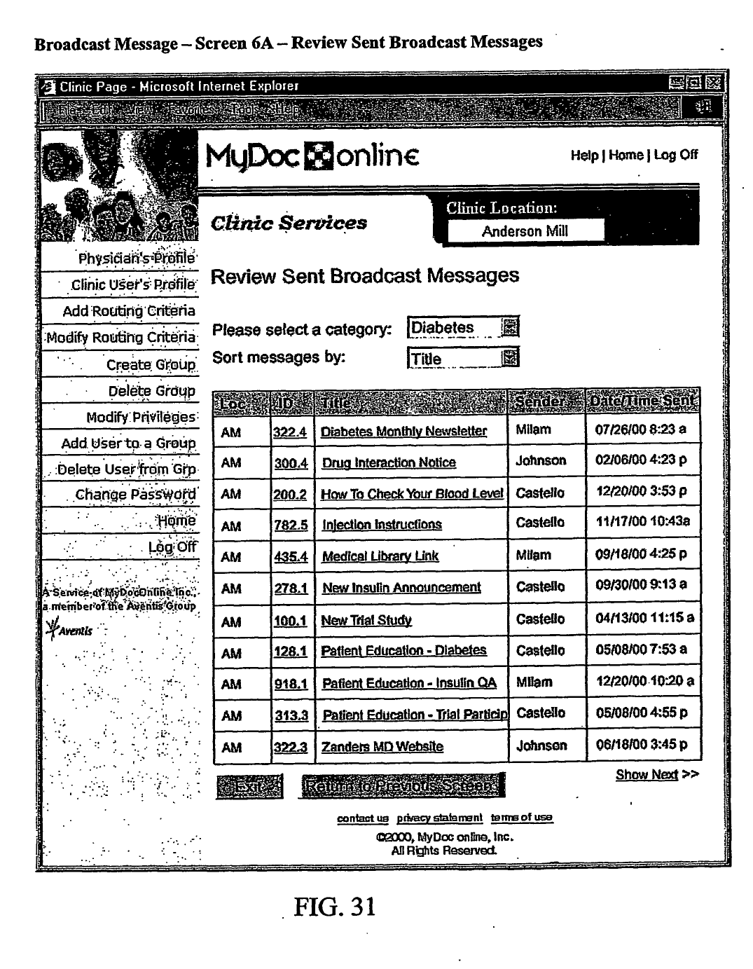

FIG. 31—Screen 6A

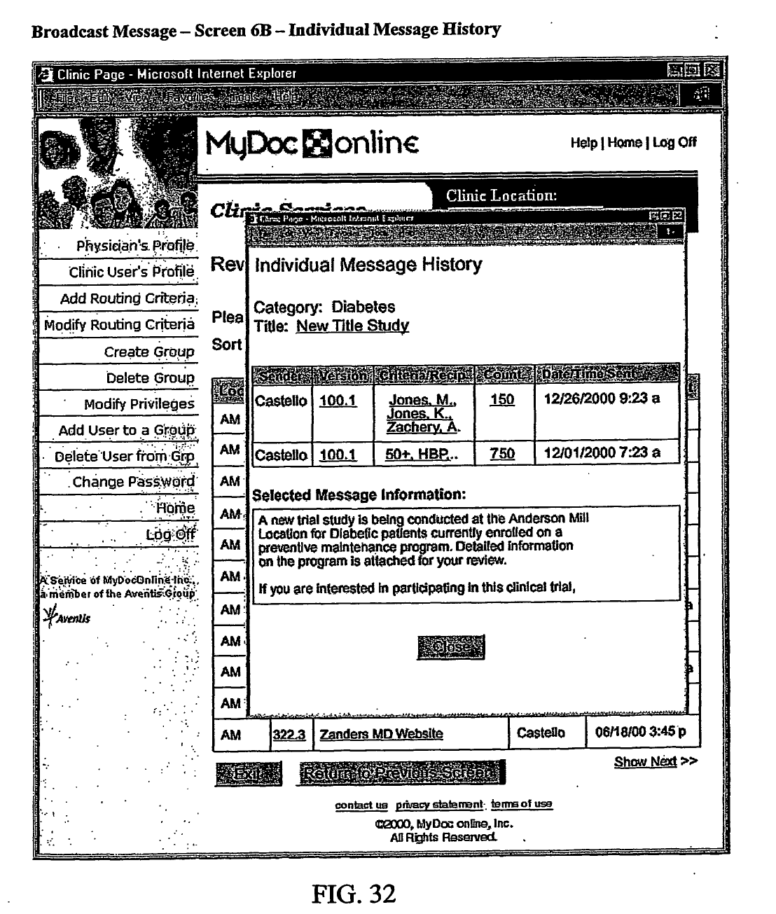

FIG. 32—Screen 6B

The broadcast messaging process is described in software specifications below which reference the tables, flowchart and screen shots of FIGS. 20-32.

Specifications:

1. Broadcast Messaging is a one-way communication from Medical Location users (MLU) to patient(s).

2. Broadcast messages can be created and sent by Medical Location users (LIU) that are designated by the Medical Organization Security Manager (MOM).

(a) Medical Organization Manager (MOM) or Medical Location Manager AM) will specify Medical Location users (MLU) that can create, alter and send Broadcast Messages. This is done by creating a user group in the security module (e.g., Broadcast Message User Group) and adding users to the group.

(b) Medical Organization Managers may send a Broadcast Message. For example, they may send a message to notify the addition of a new location.

(c) A Medical Location Manager (MLM) may send a Broadcast Message. For example, a message may be sent to notify addition of a new Physician to their location.

(d) From a usage statistics perspective, Broadcast messages are most likely sent by physicians or their clerical/nursing staff.

3. Broadcast messages can be sent to individual patient(s) or to a group of patients based on selection criteria

4. Each Broadcast Message should be sent only to the patient's MDOL portal e-mail account (address). If the patient has registered a public e-mail address, a notification should be sent to this e-mail address stating “You have mail from [<Sender>(Name of Medical Location user)] in your MyDoc Online mail box”.

5. Broadcast messages are saved and can be used as templates. Broadcast Messages cannot be sent before they are saved. FIG. 20, Table 5, shows the components of Broadcast Messages, which include Date/Time of creation, Message ID, Category, Title of Message, Message Content.

Note: “Category” in Broadcast message is a superset of categories in a Medical library module (not shown). Examples of Medical Library categories are: Diabetes, Heart condition, Other, etc. New categories can be added to Broadcast Messages via MDOL Maintenance screens. The Title of the message is assigned by the user when the message is created.

When a Broadcast message is sent, a record of this communication must be made in the MDOL activity log. Some elements of the communication that are saved in a history, as shown in FIG. 21, Table 6.

Note: Depending on what the sender of the message had chosen (e.g., Individual recipients on screen 5A, or the criteria on screen 5B), either the criteria or the resultant set of patients to whom the Broadcast message was sent should be recorded in the history.

6. The message content component (Table 5) of Broadcast messages can include:

a. Free form text

b. Link to other content within MyDoc Online

c. Link to external web site(s)

d. File attachments that have PDF, RTF or Text formats

7. By default, MyDoc patients do not receive Broadcast Messages. The Patient may “opt-in” for Broadcast Messaging in the patient profile during registration. The patient registration form includes the following message and choice:

“Your Physician or your Physician's office will periodically send out Medical Information as well as News to their patients who are connected via the Internet. This information would be sent to your MyDoc email account and you would be notified via your external email address (if available). If you would like to receive such messages, please check the box below.”

Please send these types of messages to my electronic mailbox(es).

8. All Medical Location user (MLU)s that are part of the Broadcast Message user group can perform the following functions:

a. Create a new Broadcast Message

b. Review saved Broadcast Messages

c. Alter a saved Broadcast Message

d. Send a Broadcast Message

e. View History of individual (selected) messages sent

f. View History of all messages sent

9. Version Control for Broadcast Messages

When a new message is created, a message id (like DB001—first message in the diabetes category) is given to it. A version number is also to be provided to the message. For example, the first message id may be DB001.1. When the author of the message selects to edit this message and then changes the contents and saves it, the successive version number is assigned to it, such as DB001.2. The stored message list shows the latest version of the message.

Consider the case when the message with id DB001.1 was sent to some of the patients. Then, the author changed the content of DB001.1 and saved it as DB001.2, but did not send it to anyone. Sometime later, the author changed the content of DB001.2 and saved it as DB001.3 and also sent it to some patients. In the history list of the sent messages, only DB001.1 and DB001.3 appear, since they are the only versions those were sent.

10. New Broadcast Message vs. New Version of an existing Broadcast Message

When a stored message is edited, it can be saved two ways.

a. When the message to be edited is selected, the Message content is populated in the appropriate boxes. In the “Save As” box, the Message title will be populated. If the message is saved with the same title, then a new version number is generated. For example: If DB001.1 is saved with the same title, the message id for the new Broadcast message becomes DB001.2.

b. If the message is saved with a different title, a new message id is generated.

Example

Existing Message

Message Id: DB001.2

Message Title: Diabetes Prevention

Content: Hi, there's new medicine for diabetes available.

Regards

Dr. Malone

Dr. Malone changes the content of DB001.2 to:

Hi, there's new medicine for diabetes available.

I will be available at ARC, Anderson Mill from 10.00 am to 11:00 am on 21^{st} December 2000.

Regards

Dr. Malone.

If Dr. Malone saves this message with the same title, such as “Diabetes Prevention,” then the message id becomes DB001.3. Alternatively, if Dr. Malone saves it with a new title, such as “Diabetes Alert,” then the message id will become DB002.1.

11. A Medical Location User (MLU) of one location can see all the messages sent by the other users of the same location.

12. The Medical Organization Managers (MOM) can see all the messages from all the Medical Locations.

13. The messages displayed in the stored message list can be sorted in either of the following ways:

a. Date message was sent

b. Title of the messages

c. Medical Location (This could have multiple values, if the Medical Organization Manager is viewing the screen. For Medical Location Users, they will only see their medical location.)

d. Sender's name

14. All the icons appearing in the different screens preferably have appropriate bubble helps on mouseover.

15. When the stored messages appear in a list, the mouseover on the message title triggers a layer (HTML layer), which shows the first ⅔ lines of the message.

16. In the screen 5B (Send Message to Selected Patient Population), the health criteria drop-down boxes has generic health criteria, in addition to all the specialty specific health criteria based on the specialties available in a particular Medical Location.

Example: Generic Health Criteria are 1) smoker 2) drinker.

The selected Medical Location is Anderson Mill and this location has two specialties, such as:

a Family Practice (health criteria of Family Practice are, for example, criteria 1, criteria 2)

b. Pediatrics health criteria of Pediatrics are, for example, criteria 3, criteria 4).

When a Medical Location User of Anderson Mill wants to send a message to a patient population, the health criteria drop down box shown in FIG. 22 will appear.

17. Additional notes for user interface (UI)

Screen 1: Broadcast Message Selector:

a. Create New Broadcast Message is a link to Screen 2.

b. On hover for option icons show (in order) Edit, Send, History, Remove.

c. On click for “Edit” goes to screen 3.

d. “Send” goes to screen 4.

e. “History” goes to screen 6B. This screen shows history for an individual message.

f. “Remove” deletes message from coming up on list again.

g. Review Sent Message History goes to screen 6A.

Screen 2: Create New Broadcast Message:

a. When a user selects to “Create a New Message” they select the category that they would like the message saved under.

b. When a user selects “Cancel”, “Create Another”, or “Select Recipients”, prompt for saving message if user hasn't saved.

c. “Create Another” takes user back to a blank Screen 2-“Create New Broadcast Message”.

d. “Select Recipients” goes to Screen 4.

Screen 3A: Edit Broadcast Message:

a. This screen is the first screen of “Edit Broadcast Message”. If the user selects to Change Attached File then the user will see screen 3B which checks the remove box and then shows the input file box with the browse button.

b. When a user selects “Cancel”, “Edit Another”, or “Select Recipients”, prompt for saving message if the user has made any modifications to the message or the attachments.

c. The “Select Recipients” button should only show if the message has been saved.

d. “Edit Another” sends user back to the Screen 1—Broadcast Message Selector Screen.

e. “Select Recipients” goes to Screen 4.

Screen 3B of Edit Broadcast Message:

a. On click of “Change Attachment”, show “Change Attached File” with file input box.

b. Change unchecked “Remove” box to checked.

c. When a user selects “Cancel”, “Edit Another”, or “Select Recipients”, prompt for saving message if the user has made any modifications to the message or the attachments.

d. The “Select Recipients” button only shows if the message has been saved.

e. “Edit Another” sends user back to the Screen 1—Broadcast Message Selector Screen.

f. “Select Recipients” goes to Screen 4.

Screen 4: Select Message Recipients:

a. Broadcast message title is a hyperlink to view the message in Edit mode (screen 3A).

b. Selecting “Individual Recipients” goes to screen 5A.

c. Selecting “Recipients Based on Patient Population Criteria” goes to screen 5B.

d. Selecting “Review Sent Message History” goes to screen 6A-Review History Screen.

Screen 5A: Send Message to Individual Recipients:

a. Broadcast message title is a hyperlink to view the message in Edit mode (screen 3A).

b. Provider list has an “All” option with ability to multi-select.

c. MOM has additional option to select location(s) for patient search selection.

d. Both search selections populate the “Search Results” area and then allows the user to move one/multi-select/or all over to Recipients list. On message send, duplicate messages are not allowed to be sent to the same unique user (in case sender selects name twice by accident).

e. On click for “Send Message” provide prompt for confirmation.

Screen 5B: Send Message to Patient Population:

a. Show “Patient Count” displays the count of the result set of the selected criteria in a pop up message box.

b. “Send Message” prompts user for confirmation to send.

c. “Demographics” and “Health Criteria” selections come from patient records and specialty-specific health histories, respectively.

d. “Health Criteria” are based on location specific specialties and is a combined list of generic and specialty specific criteria

e. “Health Criteria” has a “None” options that is the default on both dropdowns.

Screen 6A: Review Sent Message History Screen:

a. Broadcast message title is a hyperlink to view the individual message history detail—screen 6B—that includes the date/time sent history, message body, recipients/criteria, and count.

b. Sort Messages can be by Title, ID, Sender, Date/Time.

c. MU with privileges to send Broadcast Messages can see all messages sent from their location only.

d. MOM has the additional ability to sort by location.

e. MOM has the privilege to see all Broadcast Messages from all locations.

Screen 6B: Review Individual Sent Message History Screen:

a. Can be assessed from Screen I and Screen 6A.

b. Screen 6B shows in a pop-up window that contains detailed information regarding the message.

c. Sort messages by most recent sent message first.

d. If user hovers over “Version” or “Criteria/Recip.” Areas, then detail is shown in floating frame below table.

IV. Creation of a response message to patient e-mails using a formatted template.

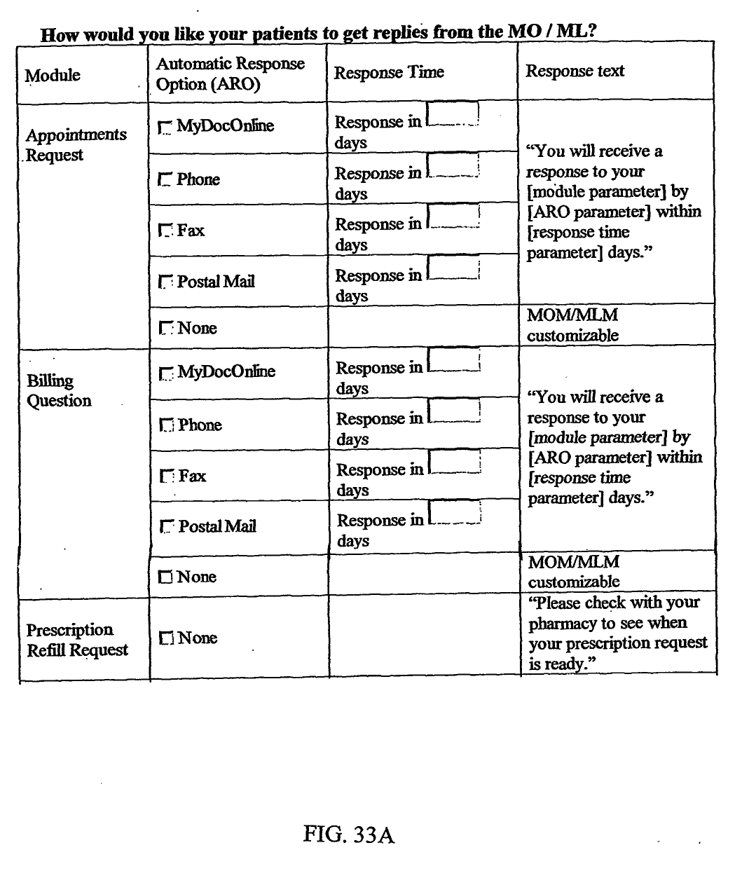

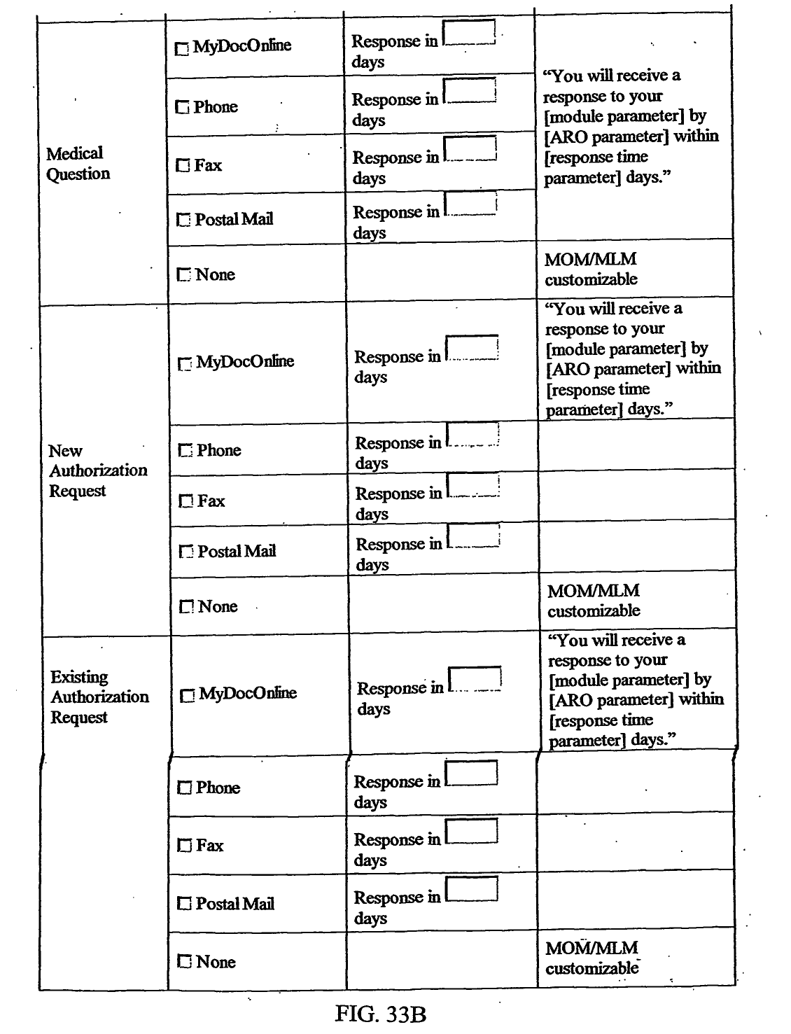

FIGS. 33A and 33B, taken together, show contents of user interface displays for allowing a medical provider to create different standardized response messages. As described above, a message response template is presented which allows the medical provider to customize text portions, time frames for response, and the preferred response communication method. For example, referring to FIG. 33A, the appointment request module of MyDoc Online allows each medical provider to customize the response text [“You will receive a response to your appointment request by <response communication method>within <response time parameter>.”]. In one preferred embodiment of the present invention, the customized data for each provider is stored in a table. However, in an alternative embodiment, the customized data may be stored in the MAT in the same manner as described above for other customized features. Similar response text may be customized for other MyDoc Online modules, such as billing, prescription refills, medical questions, and new and existing authorization requests.

This response message feature of the present invention goes well beyond the limited capabilities of e-mail management systems which allow for the creation and automatic sending of canned messages. The response message feature allows different parts of an integrated application, here different modules of MyDoc Online, to be customized for each medical provider. Thus, e-mail communications from patients in each of the modules can be responded to in exactly the manner that a particular medical provider may prefer. As discussed above, this significantly reduces the currently prohibitive cost of customizing an online application for specific medical providers.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

Changes can be made to the embodiments described above without departing from the broad inventive concept thereof. The present invention is thus not limited to the particular embodiments disclosed, but is intended to cover modifications within the spirit and scope of the present invention.

What is claimed is:

1. A computer-implemented method of scheduling appointments between customers and a plurality of service providers, at least some of the service providers having an electronic scheduling system, the method comprising:
(a) providing an electronic interface which allows for communication with:
(i) a plurality of customers who access the electronic interface via a customer user interface to request appointments, and
(ii) a plurality of electronic scheduling systems of at least some of the service providers, wherein the electronic interface includes a table that indicates which service providers have an electronic scheduling system that is available for automatic scheduling of appointments, and which service providers do not have an electronic scheduling system that is available for automatic scheduling of appointments;
(b) upon request by a customer via the user interface for an appointment with a specific service provider, determining from the table if an automatic appointment can be made; and
(c) the electronic interface sending the customer a first response if an automatic appointment can be made, and the electronic interface sending the customer a second response if an automatic appointment cannot be made.

2. The method of claim 1 wherein if it is determined from the table that an automatic appointment can be made, the method further comprising:
(d) electronically forwarding the customer's appointment request from the electronic interface to the electronic scheduling system of the specified service provider and receiving back the service provider's response at the electronic interface, wherein the first response is the service provider's response.

3. The method of claim 2 further comprising:
(e) storing customized messages in the table linked to specific service providers, wherein the first response includes any customized messages associated with the customer's requested service provider.

4. The method of claim 1 wherein the table further includes one or more conditions for selected service providers which define when the electronic scheduling system of the respective service provider is available for automatic scheduling of appointments, and wherein step (b) further uses the conditions to determine from the table if an automatic appointment can be made.

5. The method of claim 4 wherein the conditions include any one of the following: resource of the service provider, type of appointment request, date of the request, and time of day of the request.

6. The method of claim 1 wherein the second response does not indicate whether or not the service provider has an electronic scheduling system in communication with the electronic interface.

7. The method of claim 1 wherein the electronic interface communicates with the customer user interface via an electronic or global network, and the user interface is a browser.

8. The method of claim 1 wherein the second response is a request that the customer resubmit the appointment request at a subsequent point in time.

9. The method of claim 1 wherein the second response is a request to the customer that the customer submit one or more alternative appointment requests which will be subsequently confirmed.

10. The method of claim 1 wherein the service provider is a medical provider and the customers are patients or potential patients of the medical providers.

11. A computer-implemented method of customizing content of a medical inquiry session to be presented by a medical provider to a patient via a user interface, the content of the medical inquiry session including a plurality of queries and associated response types, the method comprising:
(a) storing in a table information that defines customizable elements of the medical inquiry session;
(b) presenting a medical provider with an input screen to select the customizable elements; and
(c) storing the selected customized elements in the table, wherein each medical provider may define different queries and different response types, thereby providing their respective patients with different medical inquiry sessions.

12. The method of claim 11 further comprising:
(d) storing in the table information that defines partially customizable elements of the medical inquiry session;
(e) presenting a medical provider with an input screen to select the partially customizable elements; and
(f) storing the selected partially customized elements in the table.

13. The method of claim 12 wherein the partial customization allows for variations in fixed text queries.

14. The method of claim 12 wherein the partial customization allows for variations in response types to fixed text queries.

15. The method of claim 11 wherein the response types include fixed responses and free-form text responses.

16. The method of claim 11 wherein the medical inquiry session is a medical history.

17. The method of claim 11 further comprising:
(d) providing a plurality of non-customizable content as part of the medical inquiry session.

18. The method of claim 11 further comprising:
(d) storing in the table information that defines non-customizable fixed elements of the medical inquiry session;
(e) presenting a medical provider with an input screen to select or deselect the non-customizable fixed elements; and
(f) storing the medical provider's selection/deselection choice in the table, wherein the medical inquiry session presented to the patient includes only the selected non-customizable fixed elements and the customized elements.

19. A computer-implemented method of delivering messages to patients of a medical provider, each patient including an individual profile, the method comprising:
(a) the medical provider initiating an electronic message to be broadcast to the patients, the message relating to medical information of interest to at least some of the patients;
(b) the medical provider creating a patient profile for the electronic message defining the criteria for deciding which patients should receive the electronic message;
(c) comparing the patient profile of the electronic message with the individual profile of the medical provider's patients to determine a subset of patients that match the patient profile;
(d) electronically sending the electronic message to a secure electronic mailbox of the subset of patients; and
(e) electronically sending a pickup message to an unsecure mailbox of the subset of patients informing the subset of patients that the electronic message has been sent to the patient's secure mailbox, wherein the substantive content of the electronic message does not appear in the pickup message.

20. The method of claim 19 wherein the medical provider has a web site with a host computer, and each patient has an internal e-mail address in the medical provider's host computer that is accessible by the patients via a browser, and wherein the secure mailboxes are the internal e-mail addresses of the patients in the medical provider's host computer, and the unsecure mailboxes are e-mail addresses of the patients that are not associated with the medical provider's host computer.

21. The method of claim 19 wherein the patient's individual profile includes demographics and health criteria.

22. A computer-implemented method of creating standardized responses for a plurality of different types of patient inquiries that are electronically submitted by patients to a remotely located computer management system of a medical provider, the method comprising:
(a) electronically presenting a message response template that displays at least one:
(i) standardized inquiry response that includes a fixed text portion and one or more customizable text portions, and
(ii) an input section for each customizable text portion; and
(b) a user selecting the customized text for each of the customizable text portions, wherein a plurality of medical providers may present different standardized responses to the same patient inquiries.

23. The method of claim 22 wherein the patient inquiries are selected from the group consisting of appointment requests, billing questions, prescription refill requests and medical questions.

24. The method of claim 22 wherein the customizable text portion states the time frame for a response from the medical provider.

25. The method of claim 22 wherein the customizable text portion states the communication method for a response from the medical provider.

26. An article of manufacture for scheduling appointments between customers and a plurality of service providers, at least some of the service providers having an electronic scheduling system, the article of manufacture comprising a computer-readable medium holding computer-executable instructions for performing a method comprising:
(a) providing an electronic interface which allows for communication with:
(i) a plurality of customers who access the electronic interface via a customer user interface to request appointments, and
(ii) a plurality of electronic scheduling systems of at least some of the service providers, wherein the electronic interface includes a table that indicates which service providers have an electronic scheduling system that is available for automatic scheduling of appointments, and which service providers do not have an electronic scheduling system that is available for automatic scheduling of appointments;
(b) upon request by a customer via the user interface for an appointment with a specific service provider, determining from the table if an automatic appointment can be made; and
(c) the electronic interface sending the customer a first response if an automatic appointment can be made, and the electronic interface sending the customer a second response if an automatic appointment cannot be made.

27. The article of manufacture of claim 26 wherein if it is determined from the table that an automatic appointment can be made, the computer-executable instructions perform a method further comprising:
(d) electronically forwarding the customer's appointment request from the electronic interface to the electronic scheduling system of the specified service provider and receiving back the service provider's response at the electronic interface, wherein the first response is the service provider's response.

28. The article of manufacture of claim 27 wherein the computer-executable instructions perform a method further comprising:
(e) storing customized messages in the table linked to specific service providers, wherein the first response includes any customized messages associated with the customer's requested service provider.

29. The article of manufacture of claim 26 wherein the table further includes one or more conditions for selected service providers which define when the electronic scheduling system of the respective service provider is available for automatic scheduling of appointments, and wherein step (b) further uses the conditions to determine from the table if an automatic appointment can be made.

30. The article of manufacture of claim 29 wherein the conditions include any one of the following: resource of the service provider, type of appointment request, date of the request, and time of day of the request.

31. The article of manufacture of claim 26 wherein the second response does not indicate whether or not the service provider has an electronic scheduling system in communication with the electronic interface.

32. The article of manufacture of claim 26 wherein the electronic interface communicates with the customer user interface via an electronic or global network, and the user interface is a browser.

33. The article of manufacture of claim 26 wherein the second response is a request that the customer resubmit the appointment request at a subsequent point in time.

34. The article of manufacture of claim 26 wherein the second response is a request to the customer that the customer submit one or more alternative appointment requests which will be subsequently confirmed.

35. The article of manufacture of claim 26 wherein the service provider is a medical provider and the customers are patients or potential patients of the medical providers.

36. An article of manufacture for customizing content of a medical inquiry session to be presented by a medical provider to a patient via a user interface, the content of the medical inquiry session including a plurality of queries and associated response types, the article of manufacture comprising a computer-readable medium holding computer-executable instructions for performing a method comprising:
(a) storing in a table information that defines customizable elements of the medical inquiry session;
(b) presenting a medical provider with an input screen to select the customizable elements; and
(c) storing the selected customized elements in the table, wherein each medical provider may define different queries and different response types, thereby providing their respective patients with different medical inquiry sessions.

37. The article of manufacture of claim 36 wherein the computer-executable instructions perform a method further comprising:
(d) storing in the table information that defines partially customizable elements of the medical inquiry session;
(e) presenting a medical provider with an input screen to select the partially customizable elements; and
(f) storing the selected partially customized elements in the table.

38. The article of manufacture of claim 37 wherein the partial customization allows for variations in fixed text queries.

39. The article of manufacture of claim 37 wherein the partial customization allows for variations in response types to fixed text queries.

40. The article of manufacture of claim 36 wherein the response types include fixed responses and free-form text responses.

41. The article of manufacture of claim 36 wherein the medical inquiry session is a medical history.

42. The article of manufacture of claim 36 wherein the computer-executable instructions perform a method further comprising:
(d) providing a plurality of non-customizable content as part of the medical inquiry session.

43. The article of manufacture of claim 36 wherein the computer-executable instructions perform a method further comprising:
(d) storing in the table information that defines non-customizable fixed elements of the medical inquiry session;
(e) presenting a medical provider with an input screen to select or deselect the non-customizable fixed elements; and
(f) storing the medical provider's selection/deselection choice in the table, wherein the medical inquiry session presented to the patient includes only the selected non-customizable fixed elements and the customized elements.

44. An article of manufacture for delivering messages to patients of a medical provider, each patient including an individual profile, the article of manufacture comprising a computer-readable medium holding computer-executable instructions for performing a method comprising:
(a) the medical provider initiating an electronic message to be broadcast to the patients, the message relating to medical information of interest to at least some of the patients;
(b) the medical provider creating a patient profile for the electronic message defining the criteria for deciding which patients should receive the electronic message;
(c) comparing the patient profile of the electronic message with the individual profile of the medical provider's patients to determine a subset of patients that match the patient profile;
(d) electronically sending the electronic message to a secure electronic mailbox of the subset of patients; and
(e) electronically sending a pickup message to an unsecure mailbox of the subset of patients informing the subset of patients that the electronic message has been sent to the patient's secure mailbox, wherein the substantive content of the electronic message does not appear in the pickup message.

45. The article of manufacture of claim 44 wherein the medical provider has a web site with a host computer, and each patient has an internal e-mail address in the medical provider's host computer that is accessible by the patients via a browser, and wherein the secure mailboxes are the internal e-mail addresses of the patients in the medical provider's host computer, and the unsecure mailboxes are e-mail addresses of the patients that are not associated with the medical provider's host computer.

46. The article of manufacture of claim 44 wherein the patient's individual profile includes demographics and health criteria.

47. An article of manufacture for creating standardized responses for a plurality of different types of patient inquiries that are electronically submitted by patients to a remotely located computer management system of a medical provider, the article of manufacture comprising a computer-executable medium holding computer-executable instructions for performing a method comprising:
(a) electronically presenting a message response template that displays at least one:
(i) standardized inquiry response that includes a fixed text portion and one or more customizable text portions, and
(ii) an input section for each customizable text portion; and
(b) a user selecting the customized text for each of the customizable text portions, wherein a plurality of medical providers may present different standardized responses to the same patient inquiries.

48. The article of manufacture of claim 47 wherein the patient inquiries are selected from the group consisting of appointment requests, billing questions, prescription refill requests and medical questions.

49. The article of manufacture of claim 47 wherein the customizable text portion states the time frame for a response from the medical provider.

50. The article of manufacture of claim 47 wherein the customizable text portion states the communication method for a response from the medical provider.
